(19) United States
(12) Patent Application Publication
(10) Pub. No.: US 2026/0343176 A1
(43) Pub. Date: Oct. 29, 2026

(54) DISTANCE CONDITION CONFIGURATION AND TRIGGERING METHODS IN WIRELESS COMMUNICATION NETWORK AND DEVICE

(71) Applicant: CHINA SATELLITE NETWORK INNOVATION CO., LTD, Beijing (CN)

(72) Inventors: Dongqing QI, Beijing (CN); Ge MANG, Beijing (CN); Gaojian WANG, Beijing (CN); Rong GAO, Beijing (CN); Hua ZHONG, Beijing (CN)

(21) Appl. No.: 19/697,333

(22) Filed: Jun. 3, 2026

Related U.S. Application Data
(63) Continuation of application No. PCT/CN2025/123398, filed on Sep. 23, 2025.

(30) Foreign Application Priority Data
Apr. 24, 2025 (CN) 202510526859.4

(51) Int. Cl. H04W 4/02; H04W 4/021; H04W 84/06

(52) U.S. Cl. CPC H04W 4/023; H04W 4/021; H04W 84/06

(57) ABSTRACT

The present disclosure relates to the field of wireless communication technologies, and provides distance condition configuration and triggering methods in a wireless communication network, and a device. The method includes: configuring a distance condition that includes an area described by a combination of a plurality of subareas, wherein each of the subareas is a circular subarea described by a reference location and a distance threshold; and sending a configuration message carrying the distance condition to a terminal device, so that the terminal device determines whether to perform a predefined action according to the distance condition. Embodiments of the present disclosure can improve the applicable scope of distance-based conditions in the wireless communication network.

### CROSS REFERENCE TO RELATED APPLICATION

The present application is a continuation of International Patent Application No. PCT/CN2025/123398, filed on Sep. 23, 2025, which claims the priority of Chinese Patent Application No. 202510526859.4, entitled “Distance condition configuration and triggering methods in wireless communication network and device” and filed on Apr. 24, 2025, both of which are incorporated herein by reference in their entireties.

### TECHNICAL FIELD

The present disclosure relates to the field of wireless communication technologies, and particularly, to distance condition configuration and triggering methods in a wireless communication network and a device.

### BACKGROUND

In the existing 3^{rd} Generation Partnership Project (3GPP) protocols, a plurality of events (conditions) for terminal device measurement reports are defined, including a distance-based measurement event (hereinafter referred to as distance event). That is, the distance event is one of the conditions that a terminal device needs to satisfy when reporting a measurement report. However, the distance event defined in the existing 3GPP protocols is generally used to describe a lunar-shaped area, making it difficult to describe more complex scenarios and resulting in a narrow applicable scope.

### SUMMARY

The object of the embodiments of the present disclosure is to provide distance condition configuration and triggering methods in a wireless communication network and a device, so as to improve the applicable scope of distance-based conditions in the wireless communication network.

In order to achieve the above object, in an aspect, an embodiment of the present disclosure provides a distance condition configuration method in a wireless communication network, which is applied to a network device side, the method including:
configuring a distance condition that includes an area described by a combination of a plurality of subareas, wherein each of the subareas is a circular subarea described by a reference location and a distance threshold;
sending a configuration message carrying the distance condition to a terminal device, so that the terminal device determines whether to perform a predefined action according to the distance condition.

In another aspect, an embodiment of the present disclosure further provides a distance condition triggering method in a wireless communication network, which is applied to a terminal device side, the method including:
receiving a configuration message carrying a distance condition sent by a network device, wherein the distance condition includes an area described by a combination of a plurality of subareas, and each of the subareas is a circular subarea described by a reference location and a distance threshold;
determining whether to perform a predefined action according to the distance condition.

In another aspect, an embodiment of the present disclosure further provides a distance condition configuration apparatus in a wireless communication network, including:
a configuration module configured to configure a distance condition for an area described by a combination of a plurality of subareas, wherein each of the subareas is a circular subarea described by a reference location and a distance threshold;
a sending module configured to send a configuration message carrying the distance condition to a terminal device, so that the terminal device determines whether to perform a predefined action according to the distance condition.

In another aspect, an embodiment of the present disclosure further provides a distance condition triggering apparatus in a wireless communication network, including:
a receiving module configured to receive a configuration message carrying a distance condition sent by a network device, wherein the distance condition includes an area described by a combination of a plurality of subareas, and each of the subareas is a circular subarea described by a reference location and a distance threshold;
a determination module configured to determine whether to perform a predefined action according to the distance condition.

In another aspect, an embodiment of the present disclosure further provides a network device, including:
at least one processor; and
at least one memory which stores instructions thereon, wherein when executed individually or collectively by the at least one processor, the instructions cause the network device to perform the afore-mentioned distance condition configuration method in the wireless communication network.

In another aspect, an embodiment of the present disclosure further provides a terminal device, including:
at least one processor; and
at least one memory which stores instructions thereon, wherein when executed individually or collectively by the at least one processor, the instructions cause the terminal device to perform the afore-mentioned distance condition triggering method in the wireless communication network.

In another aspect, an embodiment of the present disclosure further provides a computer storage medium which stores instructions thereon, wherein when executed individually or collectively by at least one processor of a computer device, the instructions cause the computer device to perform the afore-mentioned methods.

As can be seen from the above technical solutions provided by the embodiments of the present disclosure, a distance condition for an area described by a combination of a plurality of subareas is configured in the embodiments of the present disclosure, wherein each of the subareas is a circular subarea described by a reference location and a distance threshold. In this way, through the combination of a plurality of circular subareas (e.g., intersecting combination, union combination, etc.), areas with more shapes and higher complexity can be described. As a result, the solutions are more adaptable to the description of inter-layer coverage areas in multi-layer overlapping networking, as well as the refined description of areas within beams or cells (i.e., a subarea may be a coverage area at the granularity of a beam or a cell), thereby improving the applicable scope of the distance-based conditions in the wireless communication network.

### BRIEF DESCRIPTION OF DRAWINGS

To illustrate the technical solutions in the embodiments of the present disclosure or in the prior art more clearly, the drawings to be used in the description of the embodiments or the prior art will be briefly introduced below. Obviously, the drawings involved in the following description merely illustrate some embodiments recited in the present disclosure, and those of ordinary skill in the art can obtain other drawings from these drawings without paying creative efforts. In the drawings:

FIG. 1 illustrates a flowchart of configuration and reporting of Event D1 and Event D2 in the prior art;

FIG. 2 illustrates a schematic diagram of a typical configuration of Event D1 in the prior art;

FIG. 3 illustrates a schematic diagram where a TN small area is included in an NTN small area in the prior art;

FIG. 4 illustrates a schematic diagram where Event D1 and Event D2 are not suitable for describing an overlapping area in the prior art;

FIG. 5 illustrates a flowchart of a distance condition configuration method in a wireless communication network according to some embodiments of the present disclosure;

FIG. 6 illustrates a schematic diagram of a subarea information list formed by a combination of three subareas according to an exemplary embodiment of the present disclosure;

FIG. 7 illustrates a schematic diagram of a complex TN coverage area described by the union of three subareas according to an exemplary embodiment of the present disclosure;

FIG. 8 illustrates a flowchart of a distance condition configuration method in a wireless communication network according to some other embodiments of the present disclosure;

FIG. 9 illustrates a flowchart of a distance condition configuration method in a wireless communication network according to some other embodiments of the present disclosure;

FIG. 10 illustrates a schematic diagram of refined tracking by a base station on a beam coverage area where a terminal is located according to an exemplary embodiment of the present disclosure;

FIG. 11 illustrates a schematic diagram of an overlapping area described by the intersection of two subareas according to an exemplary embodiment of the present disclosure;

FIG. 12 illustrates a flowchart of a distance condition configuration method in a wireless communication network according to some other embodiments of the present disclosure;

FIG. 13 illustrates a flowchart of a distance condition configuration method in a wireless communication network according to some other embodiments of the present disclosure;

FIG. 14 illustrates a schematic diagram where an inter-cell beam boundary is described by an overlapping area information list according to an exemplary embodiment of the present disclosure;

FIG. 15 illustrates a flowchart of a distance condition triggering method in a wireless communication network according to some embodiments of the present disclosure;

FIG. 16 illustrates a structural block diagram of a network device according to some embodiments of the present disclosure; and

FIG. 17 illustrates a structural block diagram of a terminal device according to some embodiments of the present disclosure.

### DESCRIPTION OF REFERENCE SIGNS

1600: network device;
1610, 1710: processor;
1620, 1720: memory;
1630: program;
1640: transceiver;
1650: antenna;
1700: terminal device;
1730: communication module;
1740: input unit;
1750: display;
1760: power supply.

### DETAILED DESCRIPTION

To enable those skilled in the art to better understand the technical solutions in the present disclosure, the technical solutions in the embodiments of the present disclosure will be described clearly and completely below with reference to the drawings for the embodiments of the present disclosure. Apparently, those described are merely part, rather than all, of the embodiments of the present disclosure. Based on the embodiments in the present disclosure, all other embodiments obtained by those of ordinary skill in the art without making any creative effort shall fall within the protection scope of the present disclosure.

To be noted, in the embodiments of the present disclosure, the involved user information (including but not limited to user device information, user personal information, etc.) and data (including but not limited to data used for analysis, stored data, displayed data, etc.) are all information and data authorized by the user and fully authorized by all parties. That is, the obtaining, transmission, storage, use, processing, etc. of the data in the technical solution of the present disclosure all comply with the relevant provisions of national laws and regulations.

In the description of the present disclosure, unless otherwise specified, "and/or" describes an association relationship between associated objects and indicates that three relationships may exist. For example, A and/or B may indicate the three cases: A exists alone, both A and B exist simultaneously, and B exists alone, where A and B may be singular or plural. In addition, in the description of the present disclosure, unless otherwise specified, "a plurality of" refers to two or more. "At least one of …" or a similar expression refers to any combination of the listed items, including any combination of a single item or a plurality of items. For example, “at least one of a, b, or c” may indicate “a”, “b”, “c”, “a and b”, “a and c”, “b and c”, or “a, b and c”, where each of a, b and c may be singular or plural.

In the present disclosure, the expressions "greater than" or "less than" may be used to determine whether a specific condition is satisfied, but this is merely provided as an example and are not intended to exclude the expressions of "greater than or equal to" or "less than or equal to". A condition described as "greater than or equal to" may be replaced with "greater than"; a condition described as "less than or equal to" may be replaced with "less than"; and a condition described as "greater than or equal to … and less than" may be replaced with "greater than ... and less than or equal to". In addition, hereinafter, "A to B" means at least one of the elements from A (inclusive) to B (inclusive).

In the embodiments of the present disclosure, a singular form such as "a/an" and "the" includes a plural form, and shall be understood in a broad sense as "one kind of" or "one type of" rather than being limited to the meaning of "one single". In addition, the term "said" shall be understood as including both the singular and plural forms unless the context clearly indicates otherwise. Furthermore, the term "according to" shall be understood as "at least in part according to...", and the term "based on" shall be understood as "at least in part based on..." unless the context clearly indicates otherwise.

The specification provides the operation steps of the method as illustrated in the embodiments or the flowcharts, but more or fewer operation steps may be included based on conventional or non-creative efforts. The order of the steps listed in the embodiments is merely one of the numerous possible execution orders and does not represent the sole one. In actual implementation by a system or an apparatus product, the steps may be executed in sequence or in parallel in accordance with the method in the embodiments or shown in the drawings.

To be noted, in the embodiments of the present disclosure, certain existing industry solutions such as software, components and models may be mentioned. These solutions shall be regarded as exemplary, for the only purpose of demonstrating the feasibility of implementing the technical solutions of the present disclosure, but does not mean that the applicant has adopted or necessarily will adopt such solutions.

The present disclosure uses the terms employed in some communication specifications (e.g., the 3rd Generation Partnership Project (3GPP), European Telecommunications Standards Institute (ETSI)), Extensible Radio Access Network (ERAN), Open Radio Access Network (O-RAN) to illustrate various embodiments, which is merely for illustrative purposes. Various embodiments of the present disclosure can also be easily modified and applied in other communication systems.

In the embodiments of the present disclosure, the communications between devices in a communication system may be performed in accordance with communication protocols at any stage, including but not limited to the following communication protocols: 1G (generation), 2G, 2.5G, 2.75G, 3G, 4G, 4.5G and 5G, New Radio (NR), etc., and/or other currently known or future-developed communication protocols.

To facilitate understanding, the technical terms involved in the embodiments of the present disclosure are explained below.

(1) Terminal device: refers to a device that has a wireless transceiving function and can cooperate with a network-side device to provide communication services for users. The terminal device may also be referred to as a terminal, User Equipment (UE), a user terminal, a Mobile Terminal (MT), or a user agent. For example, the terminal device may be a mobile phone, a tablet computer, a notebook computer, a wearable device, a Virtual Reality (VR) device, an Augmented Reality (AR) device, a wireless communication device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, an Internet of Things (IoT) device, a Narrowband Internet of Things (NB-IoT) device, a Vehicle-to-Everything (V2X) device, a device in Device-to-Device Communication (D2D), an Enhanced Machine Type Communication (eMTC) device, a Reduced Capability (RedCap) device, a cellular phone, a cordless phone, a Session Initiation Protocol (SIP) phone, a Wireless Local Loop (WLL) station, a Personal Digital Assistant (PDA), a client, a handheld device with a wireless communication function, a vehicle-mounted device, a ship-borne device, etc.

In scenarios such as the Internet of Things (IoT), the terminal device may also be a machine or apparatus for monitoring or measurement, including but not limited to, for example: a Machine Type Communication (MTC) terminal, a vehicle-mounted communication terminal, a Device to Device (D2D) terminal, a Machine to Machine (M2M) terminal, etc.

(2) Network device: refers to a network-side device capable of communicating with the terminal device. The network device may be located on a satellite or on the ground. The network device may also be referred to as a space base station, a satellite-borne base station, a satellite, a satellite communication node, a satellite network terminal device, a satellite communication module, or a base station, etc. The network-side device may also be referred to as an access network device or a radio access network device. The network-side device may be a Base Transceiver Station (BTS) in a Global System for Mobile Communication (GSM) or a Code Division Multiple Access (CDMA) communication system carried by a satellite; a NodeB (NB) in a Wideband Code Division Multiple Access (WCDMA) system carried by a satellite; an evolved NodeB (eNB or eNodeB) in an LTE system carried by a satellite; a base station in a terrestrial network or a Non-Terrestrial Network (NTN), such as a base station (gNB) in a 5G network carried by a satellite; a base station in a future network (e.g., a 6G network) after the 5G network carried by a satellite; a base station in a future-evolved Public Land Mobile Network (PLMN) carried by a satellite; a Transmission Reception Point (TRP) carried by a satellite; a radio controller in the scenario of a Cloud Radio Access Network (CRAN) carried by a satellite; or an urban base station, a micro base station, a pico base station or a femto base station carried by a satellite, etc. The base station may also be a terrestrial base station capable of communicating with a satellite, and may also be referred to as an Access Point (AP), a 5th generation (5G) node, a wireless point, a Transmission/Reception Point (TRP), or other terms with an equivalent technical meaning. The network device may also be a base station device carried by a High Altitude Platform Station (HAPS) with a loitering capability such as a large balloon or an airship; a base station device in a Roadside Unit (RSU); or a base station device in the Vehicle-to-Everything (V2X), etc.

Both the terminal device and the base station device may perform beamforming, but the embodiments of the present disclosure are not limited thereto. In some embodiments, the terminal may or may not perform beamforming. Likewise, the base station may or may not perform beamforming. That is, only one of the terminal and the base station may perform beamforming, or neither the terminal nor the base station may perform beamforming. In the present disclosure, a beam refers to the spatial propagation of a signal in a wireless channel, which is formed by one or more antennas or antenna elements, and this formation process may be referred to as beamforming.

In addition, the term "network side" or "network device side" refers to the side of the network, which may be a certain base station, or may include one or more network devices as mentioned above. The term "terminal side" or "terminal device side" refers to the side of the user or terminal, which may be a certain UE, or may include one or more terminal devices as mentioned above.

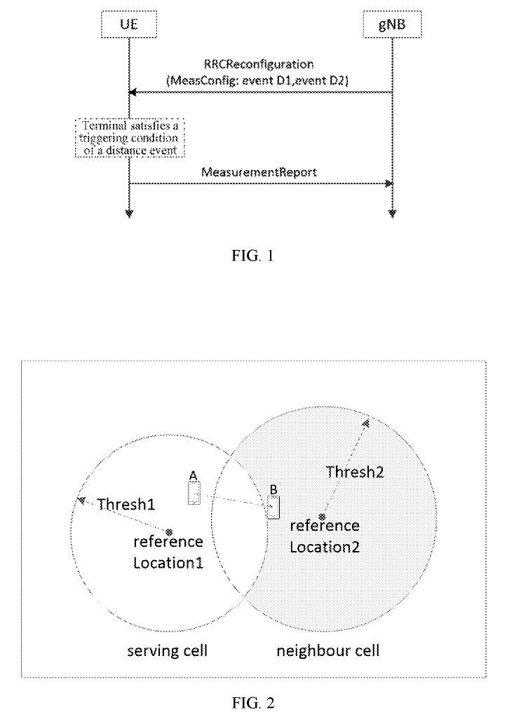

As illustrated in FIG. 1, based on the distance event defined in the existing 3GPP protocols, a network device (gNB in FIG. 1) may send a measurement configuration (MeasConfig) to a terminal device (UE in FIG. 1) via a Radio Resource Control reconfiguration message (RRCReconfiguration). In which, the measurement configuration mainly includes a measurement object (MeasObject) and a report configuration (ReportConfig). The ReportConfig includes the conditions of the distance event that need to be satisfied for the UE to report a measurement report; of course, it may also be configured to include other events (e.g., a signal strength event) as required, but the present disclosure is primarily directed to the distance event. When identifying, by means of positioning and distance measurement, that the conditions of the distance event (e.g., inequality conditions) configured in the ReportConfig are satisfied, the UE sends a measurement report message to the gNB. The gNB may obtain the area range where the UE is located through the measurement report of the distance event, and trigger the UE to execute a predefined action procedure such as cell handover accordingly.

In the existing 3GPP protocols, two types of events for distance measurement reports are defined: Event D1 and Event D2. In which, Event D1 and Event D2 are configured in a field ReportConfigNR of RRCReconfiguration. For example, when used to trigger a measurement report, Event D1 and Event D2 are configured in an EventTriggerConfig subfield of the ReportConfigNR field. For another example, when used to trigger Conditional Handover (CHO), Event D1 and Event D2 are configured in the CondTriggerConfig subfield of the ReportConfigNR field. Therefore, the judgment conditions for the events used for measurement reports or conditional handover are the same, and the configuration parameter structures are similar, the former is used to trigger the terminal to send a measurement report, and the latter is used to trigger the terminal to perform conditional handover. For the definitions and the specific parameters of these two events, please refer to the definitions of Event D1 and Event D2 in the 3GPP protocols.

With reference to FIG. 2, in the existing 3GPP protocols, two reference locations are configured in the ReportConfig within the measurement configuration for the terminal by a serving cell: reference location 1 (referenceLocation1) and reference location 2 (referenceLocation2). In addition, two distance thresholds are further configured in the ReportConfig: distance threshold 1 (distanceThreshFromReference1, abbreviated as Thresh1) and distance threshold 2 (distanceThreshFromReference2, abbreviated as Thresh2). The afore-mentioned reference locations and distance thresholds can be used to define an entering condition and a leaving condition in a distance event, i.e., the entering condition and the leaving condition can be expressed based on the inequality conditions described by the reference locations and the distance thresholds.

In the existing 3GPP protocols, the referenceLocation1 is required to be associated with the serving cell, and the referenceLocation2 is required to be associated with a neighbour cell. The reasons lie in that the circular area formed with the referenceLocation1 as a center and the distanceThreshFromReference1 as a radius is generally used to represent the coverage area of the serving cell, and the circular area formed with the referenceLocation2 as a center and the distanceThreshFromReference2 as a radius is generally used to represent the coverage area of the neighbour cell. When the terminal identifies by distance measurement that a distance from the referenceLocation1 exceeds the distanceThreshFromReference1 (Inequality D1-1 in the 3GPP protocols) and a distance from the referenceLocation2 is less than the distanceThreshFromReference2 (Inequality D1-2 in the 3GPP protocols), the entering condition for Event D1 is deemed to be satisfied, i.e., the terminal is considered to have entered the coverage area of the neighbour cell. When the entering condition is satisfied and remains so for longer than a configurable trigger time (timeToTrigger), the terminal reports a measurement report. In this way, the base station can learn from the measurement report of Event D1 triggered by the terminal that the terminal has moved from the coverage area of the serving cell to a target cell, and make a decision on cell handover based on this information.

With reference to FIG. 2, in a typical Event D1 configuration in the existing 3GPP protocols, the Inequality D1-1 and the Inequality D1-2 form two circular areas. After the terminal moving into a lunar-shaped area formed by these two circular areas (the gray area in FIG. 2), the entering condition of Event D1 will be satisfied and the terminal reports a measurement report. The terminal triggers the measurement report of Event D1 when moving from point A to the lunar-shaped area where point B is located.

In the existing 3GPP protocols, the trigger conditions for Event D2 are similar to those for Event D1. The difference lies in that the two reference locations in Event D1 are fixed, and the two reference locations in Event D2 are moving reference locations (movingReferenceLocation) that move along with the movement of a satellite or the like.

However, Event D1 and Event D2 as defined in the existing 3GPP protocols have the following problems.

When the terminal is in a RRC_CONNECTED state, the only distance events available for measurement are Event D1 and Event D2. However, the shapes that can be represented by these two distance events are limited, and they are only suitable for representing the lunar-shaped area formed between two cells, which is not applicable to many complex scenarios. Taking a combined coverage area and an interference area as examples below to illustrate that the existing Event D1 and Event D2 cannot describe complex scenarios.

### 1. The existing Event D1 and Event D2 cannot describe the combined coverage area

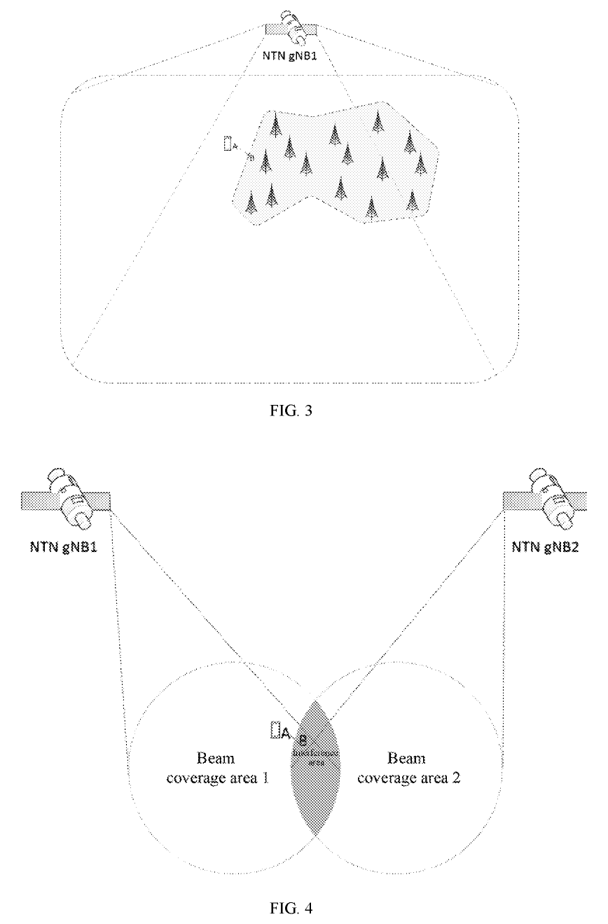

As illustrated in FIG. 3, the coverage area of a satellite-borne base station (a type of NTN base station) is generally much larger than that of a terrestrial base station (or TN base station). In addition, the coverage area of a satellite-borne base station is likely to include a TN coverage area composed of a plurality of TN base stations, such as an irregular coverage area formed by a plurality of TN base stations in FIG. 3. The satellite-borne base station needs to monitor the situation where a served terminal in the RRC_CONNECTED state enters or leaves the coverage area of the TN base station, so that after the terminal enters the TN coverage area (for example, the terminal moves from point A outside the NTN coverage area to point B inside the TN coverage area), the satellite-borne base station can configure the terminal with signal quality measurement on TN frequency points and hand over the terminal to the TN base station. However, the existing Event D1 and Event D2 cannot describe (or are difficult to accurately describe) such an irregular TN coverage area, which prevents the satellite-borne base station from accurately learning that the terminal has entered the TN coverage area and thus leads to an inaccurate timing for configuring the terminal with TN measurement. If the TN measurement timing is configured too early, it will result in invalid measurements by the terminal (moreover, the frequency deployments between NTN and TN are generally different, and the overhead of inter-frequency measurement is substantial, which will interrupt the service transmission of the terminal in an NTN serving cell). If the TN measurement timing is configured too late, it will lead to a delayed handover of the terminal to the TN coverage area, which will also affect the service quality of the terminal and waste valuable satellite-terrestrial communication resources.

### 2. The existing Event D1 and Event D2 cannot describe an interference area

Interference may exist between two areas (e.g., a beam coverage area or a cell coverage area). For example, as illustrated in FIG. 4, a beam coverage area 1 and a beam coverage area 2 overlap with each other, and inter-area interference exists in an overlapping area (the inter-area interference may result from the downlink interference between two co-frequency cells, or from the uplink interference of the terminal to the downlink of a neighbour terminal in a Time Division Duplexing (TDD) mode). In a case where the terminal enters an interference area formed by the overlap of two areas (as illustrated in FIG. 4, the terminal moves from point A to point B), if the terminal can actively report that it is in an interference area, the overhead and misjudgment of the base station in identifying the terminal interference can be reduced. However, the existing Event D1 and Event D2 cannot describe such an interference area.

In view of this, to improve the applicable scope of distance-based conditions in a wireless communication network, the embodiments of the present disclosure provide distance condition configuration and triggering methods, a network device and a terminal device in a wireless communication network.

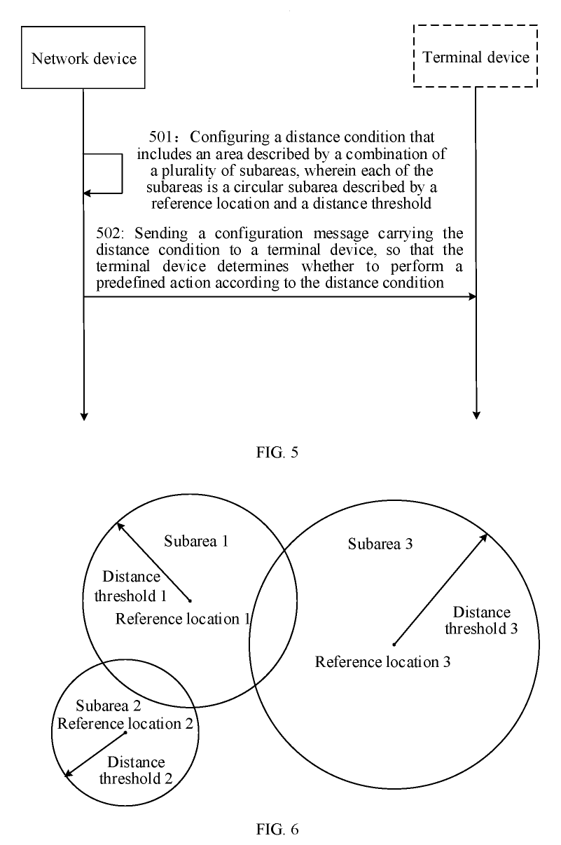

With reference to FIG. 5, an embodiment of the present disclosure provides a distance condition configuration method in a wireless communication network, which is applied to a network device side. The distance condition configuration method may include the following steps.

Step 501: Configuring a distance condition that includes an area described by a combination of a plurality of subareas, wherein each of the subareas is a circular subarea described by a reference location and a distance threshold.

Step 502: Sending a configuration message carrying the distance condition to a terminal device, so that the terminal device determines whether to perform a predefined action according to the distance condition.

In the embodiment of the present disclosure, a distance condition that includes an area described by a combination of a plurality of subareas is configured, wherein each of the subareas is a circular subarea described by a reference location and a distance threshold. In this way, through the combination of a plurality of circular subareas (e.g., intersecting combination, union combination, etc.), areas with more shapes and higher complexity can be described. As a result, the method is more adaptable to the description of inter-layer coverage areas in multi-layer overlapping networking, as well as the refined description of areas within a beam or a cell (i.e., a subarea may be a coverage area at the granularity level of a beam or a cell), thereby improving the applicable scope of the distance-based conditions (i.e., distance conditions) in the wireless communication network.

In some embodiments of the present disclosure, the area described by a combination of a plurality of subareas may be a cell coverage area or a beam coverage area of an NTN base station. Taking a satellite-borne base station as an example, since a satellite communication propagates signals through a Line of Sight (LOS) path, the coverage area of the satellite-borne base station may be described as a relatively regular circle or ellipse. In some other embodiments of the present disclosure, the area described by a combination of a plurality of subareas may also be a cell coverage area or a beam coverage area of a TN base station. In some other embodiments of the present disclosure, the area described by a combination of a plurality of subareas may be a cell coverage area or a beam coverage area of the NTN base station and the TN base station. In some other embodiments of the present disclosure, the area described by a combination of a plurality of subareas may also be any other area that needs to be described.

In some embodiments of the present disclosure, the combination of a plurality of subareas can be described in various ways (e.g., intersecting combination, union combination, etc.), which may be specifically selected as required. To facilitate understanding, the union combination and the intersecting combination are taken as examples for the following description.

### I. Description of an area by the union combination of a plurality of subareas

### (I) Definition of a newly added distance condition Cx

In some embodiments of the present disclosure, the configuring a distance condition that includes an area described by a combination of a plurality of subareas may include: configuring a distance condition Cx that includes a combined area described by the union of a plurality of subareas, wherein the distance condition Cx refers to a distance-based condition newly introduced in the existing 3GPP protocols.

In some embodiments of the present disclosure, the configuring a distance condition that includes a combined area described by the union of a plurality of subareas may include: configuring a distance condition Cx that includes a combined area described by a subarea information list (SubAreaInfoList). The subarea information list includes a plurality of pieces of subarea information (SubAreaInfo), each of which includes: a subarea identifier (subAreaId), a reference location (referenceLocation) and a distance threshold (distanceThreshFromReference); if the reference location is a moving reference location, the subarea information further includes corresponding epoch time (epochTime) and ephemeris information (ephemerisInfo).

For example, an exemplary embodiment as shown in FIG. 6 illustrates an irregular combined area described by the union of three circular subareas (subarea 1, subarea 2 and subarea 3); wherein subarea 1 (subAreaId1) is a circular subarea with reference location 1 as a center and distance threshold 1 as a radius; subarea 2 (subAreaId2) is a circular subarea with reference location 2 as a center and distance threshold 2 as a radius; and subarea 3 (subAreaId3) is a circular subarea with reference location 3 as a center and distance threshold 3 as a radius.

In some embodiments of the present disclosure, the parameters of a fixed reference location in the distance condition Cx include latitude and longitude coordinates; the parameters of a moving reference location in the distance condition Cx include latitude and longitude coordinates, epoch time and ephemeris information.

In some embodiments of the present disclosure, the distance condition that includes the moving reference location and the distance condition that includes the fixed reference location may be defined as the same condition Cx, wherein the epoch time and the ephemeris information are optional items. In this scenario, the configuring a distance condition that includes a combined area described by a subarea information list may include: configuring a distance condition that includes a combined area, which is described by a subarea information list and formed by a combination of one or more pieces of subarea information; if the subarea information of the distance condition includes epoch time and ephemeris information, it indicates that the reference location described in the subarea information is a moving reference location; and if the subarea information of the distance condition does not include the epoch time and the ephemeris information, it indicates that the reference location described in the subarea information is a fixed reference location.

In some other embodiments of the present disclosure, the distance condition that includes the moving reference location and the distance condition that includes the fixed reference location may be defined as different conditions Cx respectively. In this scenario, the configuring a distance condition that includes a combined area described by a subarea information list may include:
(1) configuring a first distance condition (condition Cx) that includes a combined area described by a subarea information list, wherein each piece of subarea information of the first distance condition includes a subarea identifier, a fixed reference location and a distance threshold;
(2) configuring a second distance condition (condition Cy) that includes a combined area described by a subarea information list, wherein each piece of subarea information of the second distance condition includes a subarea identifier, a moving reference location, a distance threshold, epoch time and ephemeris information.

In some embodiments of the present disclosure, to save the data overhead of configuration, a plurality of pieces of subarea information with the same coverage area size may share a single distance threshold; and a plurality of pieces of subarea information belonging to a same satellite may also share a set of “epoch time and ephemeris information”.

In some embodiments of the present disclosure, the distance condition Cx includes a first condition and a second condition for the combined area, wherein the first condition is used to judge whether the terminal device is located within the combined area, and the second condition is used to judge whether the terminal device is located outside the combined area.

In which, if the distance condition is a newly added distance event in a report configuration of the configuration message, the first condition may serve as an entering condition in the distance event, the second condition may serve as a leaving condition in the distance event, and both the entering condition and the leaving condition may be expressed by inequalities.

For example, in some embodiments of the present disclosure, the entering condition of the distance condition Cx may include an inequality set Mn+Hys<Tn; the entering condition is satisfied when any one of the inequalities in the inequality set Mn+Hys<Tn holds true (e.g., M1+Hys<T1 holds true). That is, if the terminal enters any circular subarea indicated by the subarea information list, the entering condition of the distance condition Cx is satisfied, i.e., the terminal device has entered the combined area described by the subarea information list. In which, Mn is a distance between the terminal device and an n-th reference location in the subarea information list (disregarding any offset); Hys is a hysteresis parameter (optional), i.e., Hys takes a value of zero when Hys is not adopted, and takes a value of a specific non-zero value when Hys is adopted; Tn is a distance threshold corresponding to the n-th reference location in the subarea information list, and n is the number of inequalities in the inequality set.

For example, in some embodiments of the present disclosure, the leaving condition of the distance condition Cx may include an inequality set Mn-Hys>Tn; the leaving condition of the distance condition Cx is satisfied only when all inequalities in the inequality set Mn-Hys>Tn hold true. That is, if the terminal does not belong to any circular subarea of the combined area, the leaving condition of the distance condition Cx is deemed satisfied, i.e., the terminal has left the combined area described by the subarea information list. In which, Mn is a distance between the terminal device and the n-th reference location in the subarea information list (disregarding any offset); Hys is a hysteresis parameter (optional), i.e., Hys takes a value of zero when Hys is not adopted, and takes a value of a specific non-zero value when Hys is adopted; Tn is a distance threshold corresponding to the n-th reference location in the subarea information list, and n is the number of inequalities in the inequality set.

### (II) Configuration of the distance condition Cx

(1) A new distance event Dx (event Dx) is configured in a report configuration (ReportConfig) field of a measurement configuration (MeasConfig) in an RRC reconfiguration message (RRCReconfiguration), to serve as a new distance condition.

In some embodiments of the present disclosure, when the distance event Dx is used to trigger a measurement report, the distance event Dx may be configured in an event trigger configuration (EventTriggerConfig) subfield of the report configuration (ReportConfig) field in the RRCReconfiguration message. In this way, when the entering condition of the distance event Dx is satisfied, the terminal may send a measurement report based on the distance event Dx to the base station.

In this scenario, the content of the measurement report needs to be extended. Specifically, the measurement report may include a subarea identifier list (subAreaIdList), which is used to report an identifier (subAreaId) of the subarea where the terminal is located to the base station. If the terminal is in an overlapping part of a plurality of subareas in the subarea identifier list, the subAreaIdList reported by the terminal includes a plurality of subAreaIds; if the terminal is in a single subarea in the subarea identifier list, the subAreaIdList includes a single subAreaId. Correspondingly, the above report configuration may further include indication information instructing the terminal device to carry the subarea identifier list in the sent measurement report, wherein the subarea identifier list includes the identifier of one or more subareas where the terminal device is located.

Further, in some embodiments of the present disclosure, the report configuration may further include indication information instructing the terminal device to update the measurement report when the subarea identifier of the subarea where the terminal device is located changes. For example, in the configuration (EventTriggerConfig) of the newly added event Dx, a reportOnAreaIdChange flag may be used to indicate the terminal to report the measurement report again when the subAreaId of the subarea where the terminal device is located changes (e.g., moving from one subarea in the subarea information list to another subarea). In other words, after the terminal reports a measurement report based on the event Dx due to the entering condition being satisfied, if the subarea identifier of the subarea where the terminal device is located changes (i.e., the terminal enters a new subarea), the terminal needs to report the identifier (subAreaId) of the new subarea to the base station through a measurement report.

In some embodiments of the present disclosure, when the distance event Dx is used to trigger conditional handover (CHO), the distance event Dx may be configured in a CondTriggerConfig subfield of the report configuration (ReportConfig) field in the RRCReconfiguration message. In this way, when the entering condition of the distance event Dx is satisfied, the terminal may initiate a random access request to a target base station.

(2) The distance condition Cx is configured in the Other Configuration (OtherConfig) field of the RRCReconfiguration message.

In some embodiments of the present disclosure, when the distance condition Cx is used to trigger UE assistance information (UAI), a subarea report configuration (subAreaReportConfig) including a subarea information list is newly added to the Other Configuration (OtherConfig) field of the RRCReconfiguration message, so that the terminal can report the subarea identifier list of the subarea wherein the terminal is located by means of the UE assistance information upon receiving the subarea report configuration, judge whether the terminal is located within an area indicated by the subarea information list, and report the UE assistance information again when the subarea where the terminal is located changes. When the terminal is configured with the subAreaReportConfig and has not yet reported the UE assistance information based on the distance condition Cx, the terminal shall send the UE assistance information based on the distance condition Cx to the base station to report the subarea identifier list of the subarea where the terminal is located. Alternatively, when the subarea where the terminal is located is different from the subarea identifier list reported by means of the UE assistance information last time (e.g., the terminal enters or leaves the combined area described by the subarea information list, or moves from one subarea described by the subarea information list to another subarea), the terminal shall re-send the UE assistance information to the base station to report the subarea identifier list of the subarea where the terminal is located again. It shall be noted that other configuration in the embodiments of the present disclosure refers to the configuration field with a field name of “OtherConfig” in the configuration message.

Further, in some embodiments of the present disclosure, the subarea report configuration may further include a transmission frequency limitation parameter for the UE assistance information; in this way, the terminal can be prevented from reporting UE assistance information too frequently, wherein the transmission frequency limitation parameter may be any one of or combination of a prohibition time (ProhibitTimer), a trigger time (timeToTrigger), or a hysteresis parameter (hysteresisLocation) (e.g., a combination of ProhibitTimer and hysteresisLocation, or a combination of timeToTrigger and hysteresisLocation). Taking ProhibitTimer as an example, if the terminal has reported its current subarea in UAI form, it is not allowed to report again within the prohibition time after the reporting. Compared with hysteresisLocation and timeToTrigger, selecting ProhibitTimer as the transmission frequency limitation parameter is easier to implement; whereas compared to ProhibitTimer, selecting hysteresisLocation or timeToTrigger as the transmission frequency limitation parameter achieves higher precision. Therefore, the specific option may be selected as required during implementation. For example, in some embodiments of the present disclosure, in a case where the terminal is configured with the subarea report configuration (subAreaReportConfig) that provides the subarea where the terminal is located to the network side, if the terminal has not sent the UE assistance information carrying the subarea identifier list after being configured with the subarea report configuration, or if the subarea where the terminal is currently located is different from the subarea identifier list reported by means of the UE assistance information last time and a timer Tx with a duration of subAreaReportProhibitTimer is not running, the terminal shall initiate the transmission of the UE assistance information to report the subarea identifier list of the subarea where the terminal is located to the network (when the terminal is located in a plurality of subareas simultaneously, a plurality of subarea identifiers shall be filled in subAreaIdList), and then start or restart the timer Tx with the duration set to subAreaReportProhibitTimer.

### (III) Reuse of a coverage area information list in a system message to configure the distance condition Cx

In some embodiments of the present disclosure, for a scenario where the combined area is a TN coverage area within an NTN coverage area, the configuring a distance condition Cx that includes a combined area described by a subarea information list may include: configuring a distance condition Cx that includes a combined area described by a subarea information list by reusing a coverage area information list (coverageAreaInfoList) in a system message (e.g., SIB25). In this way, it can further reduce modifications to the existing 3GPP specifications and is easier to implement.

In some embodiments of the present disclosure, the configuring a distance condition Cx that includes a combined area described by a subarea information list by reusing a coverage area information list in a system message may specifically include:

(1) Configuring a TN coverage area described by a union of a plurality of subareas in the coverage area information list.

For example, a plurality of circular subareas are configured through coverageAreaInfoList in SIB25, and the union of these circular subareas represents the TN coverage area. In which, the reference location may reuse tn-ReferenceLocation-r18 of CoverageAreaInfo-r18 indicated by tn-AreaId-r18 in SIB25; and the distance threshold may reuse tn-DistanceRadius-r18 of CoverageAreaInfo-r18 indicated by tn-AreaId-r18 in SIB25.

(2) Configuring a subarea identifier information list of the TN coverage area in the distance condition, and associating it with the coverage area information list.

For example, in the condition Cx, only the tn-AreaId-r18 list may be configured, and CoverageAreaInfo-r18 in SIB25 is associated with tn-AreaId-r18.

### (IV) Application of combining a plurality of subareas in a union to describe an area

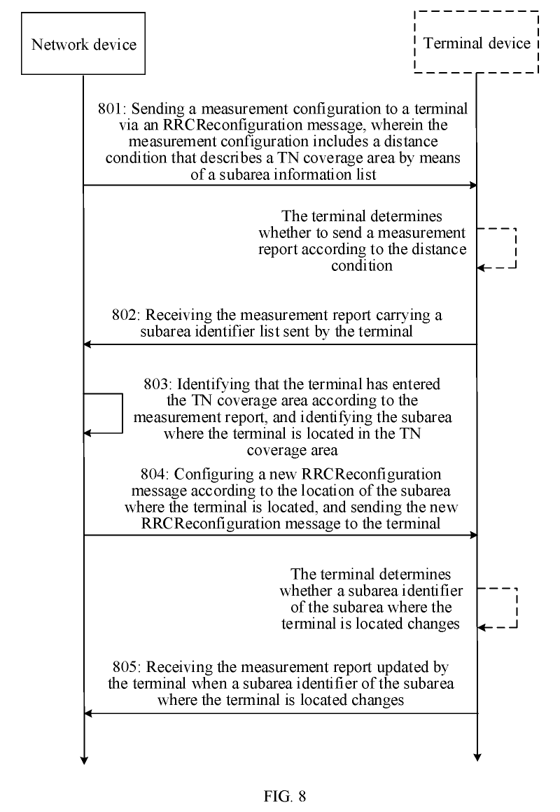

With reference to FIG. 8, an embodiment of the present disclosure provides another distance condition configuration method in a wireless communication network, which is applied to a network device side. The distance condition configuration method may include the following steps.

Step 801: Sending a measurement configuration to a terminal via an RRCReconfiguration message, wherein the measurement configuration includes a distance condition that describes a TN coverage area by means of a subarea information list.

In some embodiments of the present disclosure, the measurement configuration (MeasConfig) sent to the terminal via the RRCReconfiguration message includes an event trigger configuration (EventTriggerConfig) for a measurement report, and the event trigger configuration includes a newly added distance event (serving as the distance condition) that describes a TN coverage area by means of a subarea information list.

The terminal measures and evaluates the distance condition, and when a trigger condition (e.g., an entering condition or a leaving condition in the distance condition) is satisfied, the terminal sends a measurement report (MeasurementReport) carrying a subarea identifier list (subAreaIdList) to the network device (i.e., the terminal performs a predefined action).

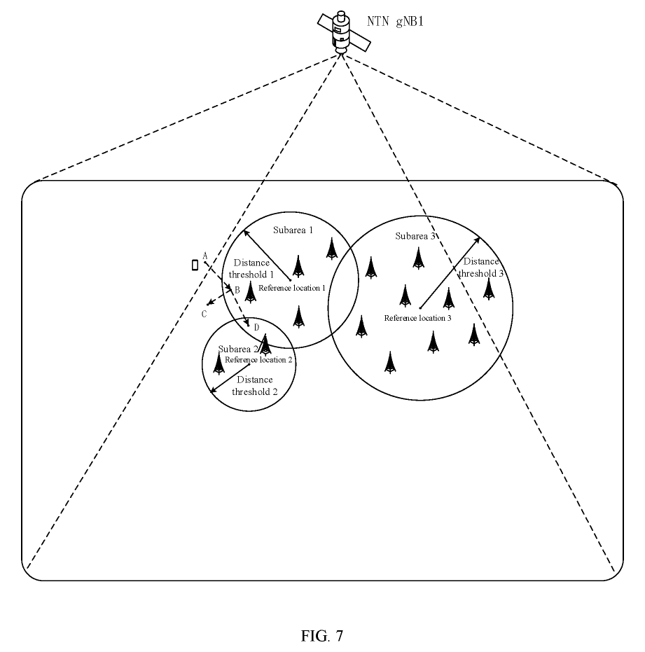

For example, in an exemplary embodiment illustrated in FIG. 7, an irregular TN coverage area described by the union of three circular subareas (subarea 1, subarea 2 and subarea 3) exists within an NTN base station (NTN gNB1). When the terminal moves from Point A to Point B and enters the TN coverage area, the entering condition of the condition Cx (e.g., the newly added Event Dx) is satisfied. After the entering condition of the condition Cx is continuously satisfied for the trigger time (timeToTrigger), the terminal reports a measurement report of the condition Cx (the measurement report carries subAreaId1).

Step 802: Receiving the measurement report carrying the subarea identifier list sent by the terminal.

Step 803: Identifying that the terminal has entered the TN coverage area according to the measurement report, and identifying the subarea where the terminal is located in the TN coverage area.

Taking the exemplary embodiment illustrated in FIG. 7 as an example, the NTN base station learns that the terminal has entered the TN coverage area based on the measurement report of the condition Cx, and learns that the terminal is in subarea 1 of the TN coverage area through the subarea identifier subAreaId1 carried in the measurement report of the condition Cx.

Step 804: Configuring a new RRCReconfiguration message according to the location of the subarea where the terminal is located, and sending the new RRCReconfiguration message to the terminal.

In some embodiments of the present disclosure, the base station may judge whether the terminal needs to perform a cell handover according to the location of the subarea where the terminal is located. When it is confirmed that the terminal needs to perform a handover, the base station may add configurations for indicating the terminal to initiate signal strength measurement, or perform a handover, or execute a conditional handover, etc. to the new RRCReconfiguration message. Taking the execution of a conditional handover as an example, the measurement configuration (MeasConfig) in the new RRCReconfiguration message may include a condition trigger configuration (CondTriggerConfig) for a conditional handover, and the condition trigger configuration includes a distance condition. In this scenario, the predefined action performed by the terminal may include, e.g., initiating signal strength measurement and executing a conditional handover. In this way, fast and accurate handover can be achieved with minimal modifications to the 3GPP protocols.

In some embodiments of the present disclosure, the base station may judge whether the terminal needs to perform accurate measurement configuration and update according to the location of the subarea where the terminal is located. If it is confirmed that the terminal needs to perform measurement configuration or update according to the subarea where the terminal is located, the base station may configure or update, in the new RRCReconfiguration message for the terminal, configurations matching the subarea such as a measurement gap configuration (measGapConfig) and an SSB measurement timing configuration (SMTC). In this way, accurate measurement configuration and update based on the subarea where the terminal is located can be achieved quickly and precisely with minimal modifications to the 3GPP protocols, which not only maintains the network service quality but also reduces the measurement power consumption and the measurement overhead of the terminal.

Step 805: Receiving the measurement report updated by the terminal when a subarea identifier of the subarea where the terminal is located changes.

The subarea where the terminal is located generally changes with the movement of the terminal and/or the NTN base station. Therefore, after sending the measurement report to the base station, the terminal monitors whether the subarea identifier of the subarea where the terminal is located changes. When the subarea identifier of the subarea where the terminal is located changes (i.e., the terminal enters a new subarea), the terminal re-sends a measurement report accordingly (i.e., updates the measurement report), so that the base station can timely and accurately learn the subarea where the terminal is located.

Taking the exemplary embodiment illustrated in FIG. 7 as an example, if the terminal moves from Point B to Point C and leaves the TN coverage area, the leaving condition of the condition Cx is satisfied. After the leaving condition of the condition Cx is continuously satisfied for the trigger time (timeToTrigger), the terminal reports a measurement report (carrying the subarea identifier list) again. At this time, the NTN base station may trigger the deletion of the configuration for the terminal’s measurement of TN frequency points based on the measurement report.

Still taking the exemplary embodiment illustrated in FIG. 7 as an example, if the terminal moves from Point B to Point D, i.e., from subarea 1 to subarea 2 of the TN coverage area, the terminal reports the measurement report again due to the change of the subarea identifier of the subarea where the terminal is located. At this time, the NTN base station may configure a new RRCReconfiguration message again based on the change of the subarea identifier in the measurement report.

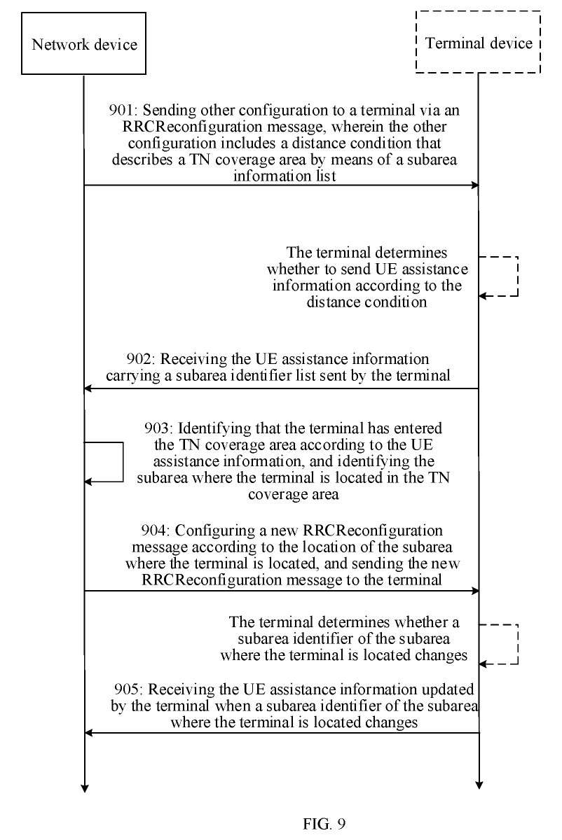

With reference to FIG. 9, an embodiment of the present disclosure provides another distance condition configuration method in a wireless communication network, which is applied to a network device side. The distance condition configuration method may include the following steps.

Step 901: Sending Other Configuration (OtherConfig) to a terminal via an RRCReconfiguration message, wherein the OtherConfig includes a distance condition that describes a TN coverage area by means of a subarea information list.

In some embodiments of the present disclosure, the OtherConfig sent to the terminal via the RRCReconfiguration message includes a trigger configuration for UE assistance information, wherein the trigger configuration includes a distance condition that describes a TN coverage area by means of a subarea information list.

The terminal measures and evaluates the distance condition, and when the trigger condition for the UE assistance information is satisfied (e.g., when the distance condition is configured for the terminal for the first time or a subAreaId of the subarea where the terminal is located changes), the terminal sends the UE assistance information carrying the subarea identifier list (subAreaIdList) to a network device (i.e., the terminal performs a predefined action). In a scenario where a transmission frequency limitation parameter for the UE assistance information is configured, after sending the UE assistance information carrying the subarea identifier list to the network device, the terminal further performs a transmission frequency limitation action according to the transmission frequency limitation parameter (e.g., starting a ProhibitTimer).

Step 902: Receiving the UE assistance information carrying the subarea identifier list sent by the terminal.

Step 903: Identifying that the terminal has entered the TN coverage area according to the UE assistance information, and identifying the subarea where the terminal is located in the TN coverage area.

Step 904: Configuring a new RRCReconfiguration message according to the location of the subarea where the terminal is located, and sending the new RRCReconfiguration message to the terminal.

Step 905: Receiving the UE assistance information updated by the terminal when a subarea identifier of the subarea where the terminal is located changes.

In some embodiments of the present disclosure, in a scenario where a transmission frequency limitation parameter is configured, when the terminal is to update the UE assistance information, it shall take into account not only whether the subarea identifier of the subarea where the terminal is located has changed, but also the transmission frequency limitation parameter. For example, taking the ProhibitTimer as the transmission frequency limitation parameter, when the terminal confirms that the subarea identifier of the subarea where the terminal is located has changed and the ProhibitTimer is not running, the terminal may re-send the UE assistance information (carrying a new subarea identifier list).

Compared with the embodiment illustrated in FIG. 8, the main difference of the embodiment illustrated in FIG. 9 is that the distance condition Cx is configured in the OtherConfig field of the RRCReconfiguration message, and the terminal reports the identifier list of the subarea where the terminal is located by means of the UE assistance information.

In some other embodiments of the present disclosure, the area described by the union of a plurality of subareas may also be used for the refined tracking within the NTN coverage area where the terminal is located.

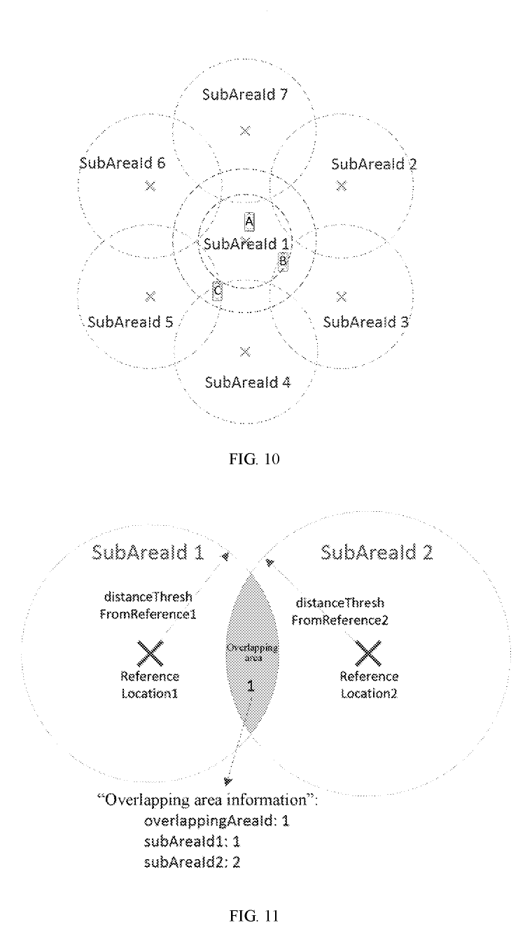

For example, in the embodiment illustrated in FIG. 10, an NTN base station may configure a subarea information list for the terminal through the condition Cx, wherein the subarea information list includes:
(1) A central area of a current serving beam (or of a serving beam): Taking a beam as an example, it may be a circular subarea described by taking the center point of the beam currently serving the terminal as referenceLocation and a distance slightly smaller than a beam coverage radius (the specific value depends on implementation) as distanceThreshFromReference. As illustrated in FIG. 10, for two concentric circles corresponding to SubAreaId 1, a relatively small circular subarea is configured to represent the central area of the beam coverage area for SubAreaId 1. (In other application scenarios, the base station may also configure a relatively large circular subarea to represent the beam coverage area for SubAreaId 1, or simultaneously configure two circular areas with the same referenceLocation but different distanceThreshFromReference and identify them with different Sub AreaIds, wherein one Sub AreaId represents the beam coverage area and the other Sub AreaId represents the central area of the beam coverage area). When the NTN base station identifies that the terminal is located in this central area (e.g., Position A of the terminal in FIG. 10), it may be considered that the terminal does not need to perform measurements on a neighbour beam, i.e., measurement relaxation for the neighbour beam may be implemented.
(2) Coverage areas of a neighbour beam (or neighbour cell): Taking a beam as an example, these may refer to a plurality of circular areas formed by taking a center point of a neighbour beam as referenceLocation and a beam coverage radius as distanceThreshFromReference. As illustrated in FIG. 10, when the beam coverage area of SubAreaId 1 is a serving beam, the coverage areas identified by SubAreaId 2 to SubAreaId 7 are all the coverage areas of the neighbour beams of the serving beam. When the NTN base station identifies that the terminal is located in the coverage area of the neighbour beam, it may be considered that the terminal only needs to perform signal measurements on the serving beam and one or two specific neighbour beams; the specific neighbour beam(s) to the terminal can be learned from the SubAreaId reported by the terminal. According to the above configuration, the terminal may actively report the SubAreaId of the subarea wherein the terminal is located to the NTN base station after entering a certain subarea. In this way, the NTN base station may configure or update refined information for the terminal accordingly, such as a measurement gap configuration (measGapConfig) and SSB Measurement Timing Configuration (SMTC) that match the subarea where the terminal is located.

For example, when the terminal is at Position B in FIG. 10 and is covered by the beams corresponding to SubAreaId 1 and SubAreaId 3, it may perform signal measurements on the beams corresponding to SubAreaId 1 and SubAreaId 3 (rather than on the remaining neighbour beams). For another example, when the terminal is at Position C in FIG. 10 and is covered by the beams corresponding to SubAreaId 1, SubAreaId 4 and SubAreaId 5, it may perform signal measurements on the beams corresponding to SubAreaId 1, SubAreaId 4 and SubAreaId 5 (rather than on the remaining neighbour beams).

### II. Description of an area by the intersecting combination of a plurality of subareas

### (I) Definition of a newly added distance condition Cm

In some embodiments of the present disclosure, the configuring a distance condition that includes an area described by a combination of a plurality of subareas may include: configuring a distance condition Cm that includes an overlapping area described by the intersection of a plurality of subareas, wherein the distance condition Cm refers to a distance-based condition newly introduced in the existing 3GPP protocols. To be distinguished from the aforementioned distance condition Cx, this new distance condition is designated as the distance condition Cm.

By configuring the distance condition that includes a combined region described by the intersection of a plurality of subareas, the area such as an overlapping area (interference area) formed by the intersection of a plurality of circular subareas can be described, wherein the overlapping area may involve interference between the cell coverage areas or interference between the beam coverage areas.

In some embodiments of the present disclosure, configuring a distance condition that includes an overlapping area described by the intersection of a plurality of subareas may include: configuring a distance condition Cm that includes an overlapping area described by an overlapping area information list (overlappingAreaInfoList), wherein the overlapping area information list includes at least one piece of overlapping area information, each of the overlapping areas is described by two intersecting subareas and identified by an overlapping area identifier; each of the subareas includes: a subarea identifier (subAreaId), a reference location (referenceLocation) and a distance threshold (distanceThreshFromReference). If the reference location is a moving reference location, the subarea information further includes corresponding epoch time (epochTime) and ephemeris information (ephemerisInfo).

For example, in an exemplary embodiment illustrated in FIG. 11, the overlapping area information list includes two subareas: subAreaId1 and subAreaId2, where subAreaId1 is a circular subarea with referenceLocation1 as a center and distanceThreshFromReference1 as a radius; subAreaId2 is a circular subarea with referenceLocation2 as a center and distanceThreshFromReference2 as a radius; subAreaId1 and subAreaId2 are intersected to form overlapping area 1; and the overlapping area information corresponding to overlapping area 1 includes:
an overlapping area identifier overlappingAreaId: 1
a subarea identifier subAreaId1: 1
a subarea identifier subAreaId2: 2

In some embodiments of the present disclosure, the parameters of a fixed reference location in the distance condition Cm include latitude and longitude coordinates; and the parameters of a moving reference location in the distance condition Cm include latitude and longitude coordinates, epoch time and ephemeris information.

In some embodiments of the present disclosure, the distance condition that includes the moving reference location and the distance condition that includes the fixed reference location may be defined as the same condition Cm, wherein the epoch time and the ephemeris information are optional items. In this scenario, the configuring a distance condition that includes an overlapping area described by an overlapping area information list may include: configuring a distance condition that includes an overlapping area, which is described by an overlapping area information list and formed by a combination of one or more pieces of overlapping area information; if the overlapping area information of the distance condition Cm includes epoch time and ephemeris information, it indicates that the reference location described in the overlapping area information is a moving reference location; and if the overlapping area information of the distance condition Cm does not include the epoch time and the ephemeris information, it indicates that the reference location described in the overlapping area information is a fixed reference location.

In some other embodiments of the present disclosure, the distance condition that includes the moving reference location and the distance condition that includes the fixed reference location may be defined as different conditions Cm respectively. In this scenario, the configuring a distance condition Cm that includes an overlapping area described by an overlapping area information list may include:
(1) configuring a first distance condition Cm (condition Cm) that includes an overlapping area described by an overlapping area information list, wherein each piece of overlapping area information of the first distance condition includes: an overlapping area identifier, a subarea identifier, a fixed reference location and a distance threshold;
(2) configuring a second distance condition Cn (condition Cn) that includes an overlapping area described by an overlapping area information list, wherein each piece of overlapping area information of the second distance condition includes: an overlapping area identifier, a subarea identifier, a moving reference location, a distance threshold, epoch time and ephemeris information.

In some embodiments of the present disclosure, to save the data overhead of configuration, a plurality of pieces of subarea information with the same coverage area size may share a single distance threshold; and a plurality of pieces of subarea information belonging to the same satellite may also share a set of “epoch time and ephemeris information”.

In the embodiments of the present disclosure, the distance condition Cm includes a third condition and a fourth condition for the overlapping area, wherein the third condition is used to judge whether the terminal device is located within the overlapping area, and the fourth condition is used to judge whether the terminal device is located outside the overlapping area. In which, if the distance condition is a newly added distance event in the report configuration of the configuration message, the third condition may be an entering condition of the distance event, the fourth condition may be a leaving condition of the distance event, and both the entering condition and the leaving condition may be expressed by inequalities.

For example, in some embodiments of the present disclosure, the entering condition of the distance condition Cm includes a set of inequality logical combinations: (Mn1+Hys<Tn1)&(Mn2+Hys<Tn2). The entering condition is satisfied when any one of the inequality logical combinations in the set of inequality logical combinations (Mn1+Hys<Tn1)&(Mn2+Hys<Tn2) holds true (e.g., the inequality logical combination (M11+Hys<T11)&(M12+Hys<T12) holds true); that is, if the terminal enters any overlapping area indicated by the overlapping area information list, the entering condition of the distance condition Cm is satisfied, i.e., the terminal has entered the overlapping area described by the overlapping area information list. In which, Mn1 is a distance from the terminal device to a first reference location of an n-th overlapping area information in the overlapping area information list (disregarding any offset); Hys is a hysteresis parameter (optional), i.e., Hys takes a value of zero when Hys is not adopted, and takes a value of a specific non-zero value when Hys is adopted; Tn1 is a distance threshold corresponding to the first reference location of the n-th overlapping area information in the overlapping area information list; & represents an AND operation; Mn2 is a distance from the terminal device to a second reference location of the n-th overlapping area information in the overlapping area information list (disregarding any offset); and Tn2 is a distance threshold corresponding to the second reference location of the n-th overlapping area information in the overlapping area information list.

For example, in some embodiments of the present disclosure, the leaving condition of the distance condition Cm includes a set of inequality logical combinations: (Mn1 - Hys > Tn1)|(Mn2 - Hys > Tn2). The leaving condition is satisfied when all the inequality logical combinations in the set of inequality logical combinations (Mn1 - Hys > Tn1)|(Mn2 - Hys > Tn2) hold true; if the terminal does not belong to any of the overlapping areas described by the overlapping area information list, the leaving condition of the distance condition Cm is deemed to be satisfied, i.e., the terminal has left all the overlapping areas described by the overlapping area information list. In which, Mn1 is a distance from the terminal device to a first reference location of an n-th overlapping area information in the overlapping area information list (disregarding any offset); Hys is a hysteresis parameter (optional), i.e., Hys takes a value of zero when Hys is not adopted, and takes a value of a specific non-zero value when Hys is adopted; Tn1 is a distance threshold corresponding to the first reference location of the n-th overlapping area information in the overlapping area information list; | represents an OR operation; Mn2 is a distance from the terminal device to a second reference location of the n-th overlapping area information in the overlapping area information list (disregarding any offset); and Tn2 is a distance threshold corresponding to the second reference location of the n-th overlapping area information in the overlapping area information list.

### (II) Configuration of the distance Condition cm

(1) A distance event Dm (event Dm) is newly added to the report configuration (ReportConfig) field of the measurement configuration (MeasConfig) in the RRCReconfiguration message, to serve as a newly added distance condition.

In some embodiments of the present disclosure, when the distance event Dm is used to trigger a measurement report, the distance event Dm may be configured in an event trigger configuration (EventTriggerConfig) subfield of the report configuration (ReportConfig) field in the RRCReconfiguration message. In this way, when the entering condition or the leaving condition of the distance event Dm is satisfied, the terminal may send a measurement report based on the distance event Dm to the base station.

In this scenario, the content of the measurement report needs to be extended. Specifically, the measurement report may include an overlapping area identifier list (overlappingAreaIdList) which is used to report an overlapping area identifier (overlappingAreaId) of the overlapping area where the terminal is located to the base station. If the terminal is in an overlapping part of a plurality of overlapping areas, the overlappingAreaIdList reported by the terminal includes a plurality of overlappingAreaIds; and if the terminal is in a single overlapping area, the overlappingAreaIdList includes a single overlappingAreaId. Correspondingly, the above report configuration may further include indication information instructing the terminal device to carry the overlappingAreaIdList in the sent measurement report, wherein the overlappingAreaIdList includes the overlappingAreaId of one or more overlapping areas where the terminal device is located.

Further, in some embodiments of the present disclosure, the report configuration may further include indication information instructing the terminal device to update the measurement report when the overlapping area identifier of the overlapping area where the terminal device is located changes. For example, in the configuration (EventTriggerConfig) of the newly added Event Dm, a reportOnAreaIdChange flag may be used to indicate that the terminal needs to report the measurement report again when its current overlappingAreaId changes. That is, after the terminal reports the measurement report based on Event Dm due to the entering condition being satisfied, if the overlapping area identifier of the overlapping area where the terminal is located changes (i.e., the terminal enters a new overlapping area), the terminal may report the identifier of the overlapping area where the terminal is located to the base station through a measurement report.

In some embodiments of the present disclosure, when the distance event Dm is used to trigger a conditional handover (CHO), the distance event Dm may be configured in a CondTriggerConfig subfield of the report configuration (ReportConfig) field in the RRCReconfiguration message. In this way, when the entering condition of the distance event Dm is satisfied, the terminal may initiate a random access request to a target base station.

(2) The distance condition Cm is configured in the Other Configuration (OtherConfig) field of the RRCReconfiguration message.

In some embodiments of the present disclosure, when the distance condition Cm is used to trigger UE assistance information (UAI), an overlapping area report configuration including overlappingAreaInfoList is newly added to the Other Configuration (OtherConfig) field of the RRCReconfiguration message, so that the terminal can report an overlapping area identifier list of the overlapping areas where the terminal is located by means of the UE assistance information upon receiving the overlapping area report configuration, judge whether the terminal is located within the area indicated by the overlapping area information list, and report the UE assistance information again when the overlapping area where the terminal is located changes. When the terminal is configured with the overlapping area report configuration and has not yet reported the UE assistance information based on the distance condition Cm, the terminal shall send the UE assistance information based on the distance condition Cm to the base station to report the overlapping area identifier list of the overlapping areas where the terminal is located. Alternatively, when the overlapping area where the terminal is located is different from the overlapping area identifier list reported by means of the UE assistance information last time (e.g., the terminal enters or leaves the combined area described by the overlapping area information list, or moves from one overlapping area described by the overlapping area information list to another overlapping area), the terminal shall re-send the UE assistance information to the base station to report the overlapping area identifier list of the overlapping areas where the terminal is located again.

Further, in some embodiments of the present disclosure, the overlapping area report configuration may further include a transmission frequency limitation parameter for the UE assistance information, in this way, the terminal can be prevented from reporting UE assistance information too frequently, wherein the transmission frequency limitation parameter may be any one or combination of a prohibition time (ProhibitTimer), a trigger time (timeToTrigger), or a hysteresis parameter (hysteresisLocation) (e.g., a combination of ProhibitTimer and hysteresisLocation, or a combination of timeToTrigger and hysteresisLocation). Taking ProhibitTimer as an example, if the terminal has reported the overlapping area where the terminal is located in the form of UAI, it is not allowed to report again within the prohibition time after the reporting.

For example, in some embodiments of the present disclosure, in a case where the terminal is configured to provide the network side with the overlapping area report configuration (overlappingAreaReportConfig) for the overlapping area where the terminal is located, if the terminal has not sent the UE assistance information carrying the overlapping area identifier list after being configured with the overlapping area report configuration, or if the current overlapping area where the terminal is located is different from the overlapping area identifier list reported by means of the UE assistance information last time and a timer Tm with a duration of OverlappingAreaReportProhibitTimer is not running, the terminal shall initiate the transmission of the UE assistance information to report the overlapping area identifier list of the overlapping area where the terminal is located to the network (when the terminal is located in a plurality of overlapping areas simultaneously, a plurality of identifiers overlappingAreaIds shall be filled in overlappingAreaIdList), and then start or restart the timer Tm with the duration set to OverlappingAreaReportProhibitTimer.

### (III) Application of combining a plurality of subareas by intersection to describe an area

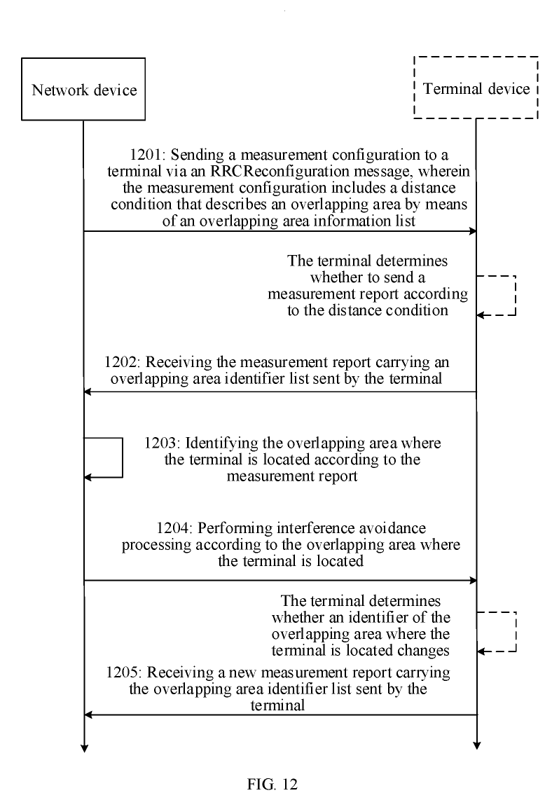

With reference to FIG. 12, an embodiment of the present disclosure provides another distance condition configuration method in a wireless communication network, which is applied to a network device side. The distance condition configuration method may include the following steps.

Step 1201: Sending a measurement configuration to a terminal via an RRCReconfiguration message, wherein the measurement configuration includes a distance condition that describes an overlapping area by means of an overlapping area information list.

In some embodiments of the present disclosure, the measurement configuration (MeasConfig) sent to the terminal via the RRCReconfiguration message includes an event trigger configuration (EventTriggerConfig) for a measurement report, wherein the event trigger configuration includes a newly added distance event (serving as the distance condition) that describes an overlapping area by means of an overlapping area information list.

The terminal measures and evaluates the distance condition, and when a trigger condition (e.g., an entering condition or a leaving condition in the newly added distance condition) is satisfied, the terminal sends a measurement report (MeasurementReport) carrying an overlapping area identifier list (overlappingAreaIdList) to the network device (i.e., the terminal performs a predefined action).

Step 1202: Receiving the measurement report carrying an overlapping area identifier list sent by the terminal.

Step 1203: Identifying the overlapping area where the terminal is located according to the measurement report.

Step 1204: Performing interference avoidance processing according to the overlapping area where the terminal is located.

In some embodiments of the present disclosure, the base station identifies whether the terminal is in an inter-cell overlapping area according to the measurement report based on the distance condition Cm (e.g., the newly added distance event Dm). When it is confirmed that the terminal is in an inter-cell overlapping area, interference avoidance processing can be performed on the terminal. For example, the base station sends a configuration message for performing interference avoidance on the terminal in the overlapping area, such as configuring differentiated time-domain or frequency-domain resources for the terminal. When it is confirmed that the terminal is not in an inter-cell overlapping area, interference avoidance processing may not be performed on the terminal. In this way, interference avoidance processing can be implemented accurately with minimal modifications to the 3GPP protocols, and the restriction of air interface resources of a terminal unaffected by interference due to performing interference avoidance processing thereon (e.g., being able to obtain only part of the frequency-domain or time-domain resources) can be avoided.

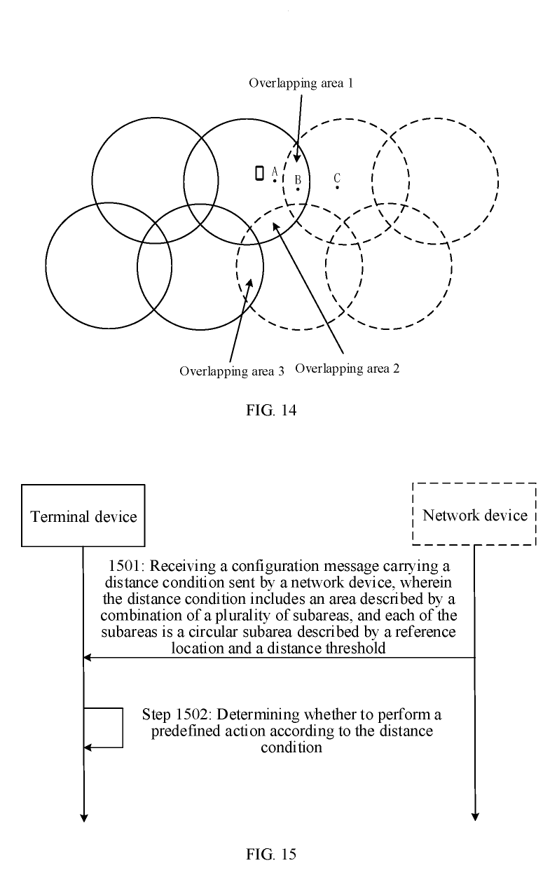

For example, in the exemplary embodiment illustrated in FIG. 14, NTN cell 1 (a solid-line circular subarea) and NTN cell 2 (a dashed-line circular subarea) use the same frequency. At a boundary of the two cells, there are beam overlapping in some areas (e.g., overlapping area 1, overlapping area 2 and overlapping area 3 in FIG. 14), and interference exists in these overlapping beam areas (e.g., co-channel interference in the downlink of the two cells in an FDD network, or interference from the uplink of the terminal to the downlink of a neighbour terminal in a TDD network). When identifying, according to the measurement report based on the condition Cm (e.g., the newly added event Dm) provided by the terminal, that the terminal is in an overlapping area (e.g., the terminal moves from Position A to Position B in overlapping area 1 in FIG. 14), the NTN base station may perform interference avoidance processing on the terminal (e.g., assigning different frequency bandwidths to the terminal by different cells for frequency-division scheduling). When identifying, according to the measurement report based on the condition Cm provided by the terminal, that the terminal is not in an overlapping area (e.g., the terminal is at Position A in FIG. 14, or the terminal moves from Position B to Position C in a non-overlapping area in FIG. 14), the NTN base station may not perform interference avoidance processing on the terminal or stop performing interference avoidance processing on the terminal.

Step 1205: Receiving a new measurement report carrying the overlapping area identifier list sent by the terminal.

The subarea where the terminal is located generally changes with the movement of the terminal and/or the NTN base station. Therefore, after sending the measurement report to the base station, the terminal monitors whether the overlapping area identifier of the overlapping area where the terminal is located changes. When the overlapping area identifier of the overlapping area where the terminal is located changes (i.e., the terminal enters a new overlapping area), the terminal re-sends a measurement report accordingly (i.e., updates the measurement report), so that the base station can timely and accurately learn the overlapping area where the terminal is located.

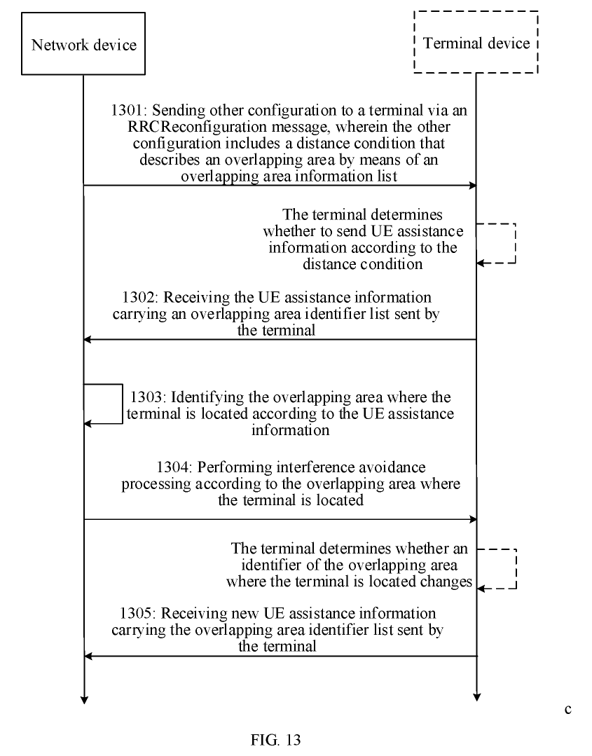

With reference to FIG. 13, an embodiment of the present disclosure provides another distance condition configuration method in a wireless communication network, which is applied to a network device side. The distance condition configuration method may include the following steps.

Step 1301: Sending Other Configuration (OtherConfig) to a terminal via an RRCReconfiguration message, wherein the OtherConfig includes a distance condition that describes an overlapping area by means of an overlapping area information list.

In some embodiments of the present disclosure, the OtherConfig sent to the terminal via the RRCReconfiguration message includes a trigger configuration for UE assistance information, wherein the trigger configuration includes a distance condition that describes an overlapping area by means of an overlapping area information list.

The terminal measures and evaluates the distance condition, and sends the UE assistance information carrying the overlapping area identifier list to a network device (i.e., the terminal performs a predefined action).

Step 1302: Receiving the UE assistance information carrying an overlapping area identifier list sent by the terminal.

Step 1303: Identifying the overlapping area where the terminal is located according to the UE assistance information.

Step 1304: Performing interference avoidance processing according to the overlapping area where the terminal is located.

Step 1305: Receiving new UE assistance information carrying the overlapping area identifier list sent by the terminal.

Compared with the embodiment illustrated in FIG. 12, the main difference of the embodiment illustrated in FIG. 13 is that the distance condition Cm is configured in the OtherConfig field of the RRCReconfiguration message, and the terminal reports the overlapping area identifier list of the overlapping areas where the terminal is located by means of the UE assistance information.

With reference to FIG. 15, an embodiment of the present disclosure provides a distance condition triggering method in a wireless communication network, which is applied to a terminal device side, and the distance condition triggering method may include the following steps.

Step 1501: Receiving a configuration message carrying a distance condition sent by a satellite base station, wherein the distance condition includes an area described by a combination of a plurality of subareas, and each of the subareas is a circular subarea described by a reference location and a distance threshold;

Step 1502: Determining whether to perform a predefined action according to the distance condition.

In the distance condition triggering method according to some embodiments of the present disclosure, the configuration message of the distance condition includes:
a distance condition for a combined area described by a union of a plurality of subareas.

In the distance condition triggering method according to some embodiments of the present disclosure, the distance condition for a combined area described by a union of a plurality of subareas includes:
a distance condition for a combined area described by a subarea information list; wherein the subarea information list includes a plurality of pieces of subarea information; each piece of subarea information includes a subarea identifier, a reference location and a distance threshold.

In the distance condition triggering method according to some embodiments of the present disclosure, the configuration message of the distance condition includes:
a distance condition for an overlapping area described by an intersection of a plurality of subareas.

In the distance condition triggering method according to some embodiments of the present disclosure, the distance condition for an overlapping area described by an intersection of a plurality of subareas includes:
a distance condition for an overlapping area described by an overlapping area information list, wherein the overlapping area information list includes at least one piece of overlapping area information; each of the overlapping areas is described by two intersecting subareas and identified by an overlapping area identifier; and each of the subareas includes: a subarea identifier, a reference location and a distance threshold.

In the distance condition triggering method according to some embodiments of the present disclosure, the area includes any one of:
a cell coverage area; or
a beam coverage area.

In the distance condition triggering method according to some embodiments of the present disclosure, the receiving a configuration message carrying a distance condition sent by a network device includes:
receiving a configuration message carrying a measurement configuration or other configuration sent by a network device, wherein the measurement configuration includes an event trigger configuration for a measurement report or a conditional trigger configuration for conditional handover, wherein the distance condition is included in the event trigger configuration, the conditional trigger configuration or the other configuration, wherein the other configuration refers to a configuration field with a field name of “OtherConfig” in the configuration message.

In the distance condition triggering method according to some embodiments of the present disclosure, the report configuration further includes:
indication information instructing the terminal device to carry a subarea identifier list in the sent measurement report, wherein the subarea identifier list includes subarea identifiers of one or more subareas where the terminal device is located.

In the distance condition triggering method according to some embodiments of the present disclosure, the report configuration further includes:
indication information instructing the terminal device to update the measurement report when the subarea identifier of the subarea where the terminal device is located changes.

In the distance condition triggering method according to some embodiments of the present disclosure, the report configuration further includes:
indication information instructing the terminal device to carry an overlapping area identifier list in the sent measurement report, wherein the overlapping area identifier list includes overlapping area identifiers of one or more overlapping areas where the terminal device is located.

In the distance condition triggering method according to some embodiments of the present disclosure, the report configuration further includes:
indication information instructing the terminal device to update the measurement report when the overlapping area identifier of the overlapping area where the terminal device is located changes.

In the distance condition triggering method according to some embodiments of the present disclosure, a subarea report configuration that includes a subarea information list is newly added to the other configuration, so that the terminal device is capable of reporting a subarea identifier list of sub-areas where the terminal device is located by means of UE assistance information upon receiving the subarea report configuration, judging whether the terminal device is within an area indicated by the subarea information list, and reporting the UE assistance information again when the subarea where the terminal device is located changes.

In the distance condition triggering method according to some embodiments of the present disclosure, the subarea report configuration further includes a transmission frequency limitation parameter for the UE assistance information.

In the distance condition triggering method according to some embodiments of the present disclosure, an overlapping area report configuration that includes an overlapping area information list is newly added to the other configuration, so that the terminal device is capable of reporting the overlapping area identifier list of the overlapping area where the terminal device is located by means of the UE assistance information upon receiving a subarea report configuration, judging whether the terminal device is within an area indicated by the overlapping area information list, and reporting the UE assistance information again when the overlapping area where the terminal device is located changes.

In the distance condition triggering method according to some embodiments of the present disclosure, the overlapping area report configuration further includes a transmission frequency limitation parameter for the UE assistance information.

In the distance condition triggering method according to some embodiments of the present disclosure, the transmission frequency limitation parameter includes any one or combination of:
a prohibition time (ProhibitTimer);
a trigger time (timeToTrigger); or
a hysteresis parameter (hysteresisLocation).

In the distance condition triggering method according to some embodiments of the present disclosure, the performing a predefined action includes one of:
sending a measurement report based on the distance condition to the network device;
sending UE assistance information based on the distance condition to the network device;
performing conditional handover; or
initiating signal strength measurement.

In the distance condition triggering method according to some embodiments of the present disclosure, the method further includes:
receiving a new configuration message carrying a measurement configuration or other configuration sent by the network device. In the distance condition triggering method according to some embodiments of the present disclosure, the new configuration message includes any one of:
a configuration message instructing the terminal device to initiate signal strength measurement;
a configuration message instructing the terminal device to configure or update a measurement gap configuration and an SSB measurement time configuration;
a configuration message instructing the terminal device to perform handover or conditional handover; or
a configuration message for performing interference avoidance on the terminal device located in the overlapping area.

In the distance condition triggering method according to some embodiments of the present disclosure, the distance condition includes a newly added distance event in the report configuration.

Although the process flows described above include a plurality of operations occurring in a specific order, it shall be clearly understood that these processes may include more or fewer operations, and these operations may be performed sequentially or in parallel (e.g., using a parallel processor or in a multi-threaded environment).

An embodiment of the present disclosure further provides a distance condition configuration apparatus in a wireless communication network, which includes:
a configuration module configured to configure a distance condition for an area described by a combination of a plurality of subareas, wherein each of the subareas is a circular subarea described by a reference location and a distance threshold;
a sending module configured to send a configuration message carrying the distance condition to a terminal device, so that the terminal device determines whether to perform a predefined action according to the distance condition.

An embodiment of the present disclosure further provides a distance condition triggering apparatus in a wireless communication network, which includes:
a receiving module configured to receive a configuration message carrying a distance condition sent by a network device, wherein the distance condition includes an area described by a combination of a plurality of subareas, and each of the subareas is a circular subarea described by a reference location and a distance threshold;
a determination module configured to determine whether to perform a predefined action according to the distance condition.

An embodiment of the present disclosure further provides a network device, which may be a base station for example, but the present disclosure is not limited thereto and may also adopt any other network device.

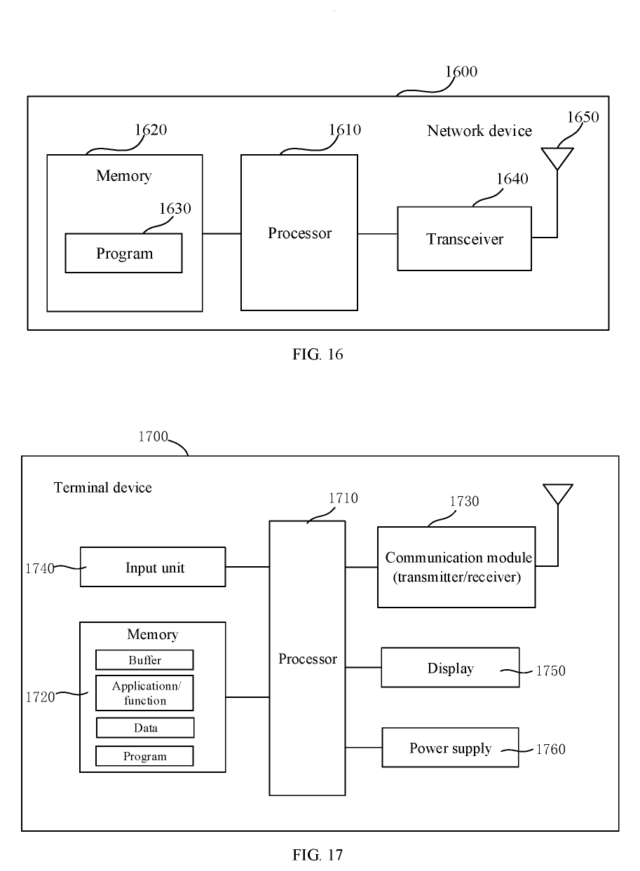

FIG. 16 illustrates a structural diagram of a network device according to an embodiment of the present disclosure. As illustrated in FIG. 16, the network device 1600 may include a processor 1610 (e.g., a central processing unit (CPU)) and a memory 1620 that is coupled to the processor 1610. The memory 1620 may store various types of data and further store a program 1630 for information processing, and the program 1630 is executed under the control of the processor 1610.

For example, the processor 1610 may be configured to execute the program to implement the distance condition configuration method in the wireless communication network as described in the foregoing embodiments. For example, the processor 1610 may be configured to perform the following controls: configuring a distance condition for an area described by a combination of a plurality of subareas, wherein each of the subareas is a circular subarea described by a reference location and a distance threshold; sending a configuration message carrying the distance condition to a terminal device, so that the terminal device determines whether to perform a predefined action according to the distance condition.

In addition, as illustrated in FIG. 16, the network device 1600 may further include a transceiver 1640, an antenna 1650, etc. The functions of the above components are similar to those in the prior art, and will not be repeated here. It shall be noted that the network device 1600 does not necessarily include all the components illustrated in FIG. 16. In addition, the network device 1600 may further include components not illustrated in FIG. 16, which may refer to the prior art.

An embodiment of the present disclosure further provides a terminal device. As illustrated in FIG. 17, the terminal device 1700 may include a processor 1710 and a memory 1720; the memory 1720 stores data and a program and is coupled to the processor 1710. It shall be noted that this figure is exemplary, and any other type of structure may also be used to supplement or replace this structure to realize telecommunication functions or other functions.

For example, the processor 1710 may be configured to execute the programs to implement the distance condition triggering method in the wireless communication network as described in the foregoing embodiments. For example, the processor 1710 may be configured to perform the following controls: receiving a configuration message carrying a distance condition sent by a network device, wherein the distance condition includes an area described by a combination of a plurality of subareas, and each of the subareas is a circular subarea described by a reference location and a distance threshold; determining whether to perform a predefined action according to the distance condition.

As illustrated in FIG. 17, the terminal device 1700 may further include a communication module 1730, an input unit 1740, a display 1750 and a power supply 1760. The functions of the above components are similar to those in the prior art, and will not be repeated here. It shall be noted that the terminal device 1700 does not necessarily include all the components illustrated in FIG. 17, and the above components are not essential. In addition, the terminal device 1700 may further include components not illustrated in FIG. 17, which may refer to the prior art.

For the convenience of description, the above apparatus is described by being divided into various units in terms of function. Of course, during implementation of the present disclosure, the functions of various units may be implemented in one or more pieces of software and/or hardware.

An embodiment of the present disclosure further provides a computer storage medium which stores instructions thereon, wherein when executed individually or collectively by at least one processor of a computer device, the instructions cause the computer device to perform the distance condition configuring or triggering method in the wireless communication network.

The present disclosure is described with reference to a flowchart and/or a block diagram of the method, the device (system), the computer-readable storage medium and the computer program product according to some embodiments of the present disclosure. It shall be appreciated that each flow and/or block in the flowchart and/or the block diagram and a combination of flows and/or blocks in the flowchart and/or the block diagram can be realized by computer program instructions. Those computer program instructions can be provided to a general computer, a dedicated computer, an embedded processor or a processor of other programmable data processing device to produce a machine, so that the instructions executed by the processor of the computer or other programmable data processing device produce means for realizing specified functions in one or more flows in the flowchart and/or one or more blocks in the block diagram.

These computer program instructions may also be stored in a computer readable memory capable of guiding the computer or other programmable data processing devices to work in a particular manner, so that the instructions stored in the computer readable memory produce manufacture articles including an instructing device which realizes function(s) specified in one or more flows in the flowchart and/or one or more blocks in the block diagram.

These computer program instructions may also be loaded onto the computer or other programmable data processing devices, so that a series of operation steps are performed on the computer or other programmable devices to produce a processing realized by the computer, thus the instructions executed on the computer or other programmable devices provide step(s) for realizing function(s) specified in one or more flows in the flowchart and/or one or more blocks in the block diagram.

In a typical configuration, the computing device includes one or more processors (CPUs), an input/output interface, a network interface and a memory.

The memory may have the form of a volatile memory, a Random-Access Memory (RAM) and/or a nonvolatile memory such as Read-Only Memory (ROM) or a flash RAM, etc. among the computer readable medium. The memory is an example of the computer readable medium.

The computer-readable medium includes permanent and non-permanent, removable and non-removable media, which can realize the information storage in any method or technique. The information can be computer readable instructions, data structures, program modules or other data. An example of the computer storage medium includes, but not limited to, a Phase-Change Random-access Memory (PRAM), a static random access memory (SRAM), a dynamic random access memory (DRAM), other types of random access memory (RAM), a read-only memory (ROM), an electrically-erasable programmable read-only memory (EEPROM), a flash memory or other memory techniques, a compact disk read only memory (CD-ROM), a digital versatile disc (DVD) or other optical storages, magnetic cassette tapes, magnetic diskette storage or other magnetic storage device or any other non-transmission medium, which can be used for the storage of information accessible to a computing device. According to the definitions herein, the computer readable medium does not include transitory media, such as modulated data signal and carrier wave.

Those skilled in the art shall appreciate that the embodiments of the present disclosure can be provided as methods, systems or computer program products. Therefore, the embodiments of the present disclosure can take the form of a full hardware embodiment, a full software embodiment, or an embodiment combining software and hardware. Moreover, the embodiments of the present disclosure can take the form of a computer program product implemented on one or more computer usable storage mediums (including, but not limited to, a magnetic disc memory, CD-ROM, optical storage, etc.) containing therein computer usable program codes.

The embodiments of the present disclosure may be described in the general context of computer executable instructions executed by the computer, e.g., the program module. In general, the program module includes routine, program, object, component, data structure, etc. executing a particular task or realizing a particular abstract data type. The embodiments of the present disclosure may also be put into practice in the distributed computing environments in which tasks are executed by remote processing devices connected through a communication network. In the distributed computing environments, the program modules may be located in the local and remote computer storage medium including the storage device.

It shall also be understood that in the embodiments of the present disclosure, the term “and/or” is only an association relationship that describes the associated objects, indicating that there may be three relationships. For example, A and/or B may indicate the three cases: A exists alone, A and B both exist, and B exists alone. In addition, the character “/” in the present disclosure generally indicates that the contextually associated objects are in an “or” relationship.

The various embodiments of the present disclosure are all described in a progressive manner, and the same or similar portions of the various embodiments can refer to each other. Each embodiment lays an emphasis on its distinctions from other embodiments. In particular, the system embodiment is simply described since it is substantially similar to the method embodiment, and please refer to the descriptions of the method embodiment for the relevant portions.

In the description of the present disclosure, the description of reference terms “one embodiment”, “some embodiments”, “an example”, “a specific example” or “some examples” and the like mean that the specific features, structures, materials, or characteristics described in conjunction with the embodiment(s) or example(s) are included in at least one embodiment or example of the present disclosure. In the present disclosure, the schematic expressions of the above terms do not necessarily aim at the same embodiment or example. Moreover, the described specific features, structures, materials, or characteristics may be combined in any one or more embodiments or examples in a suitable manner. In addition, those skilled in the art can combine and integrate different embodiments or examples described in the present disclosure and features thereof if there is no contradiction to each other.

Those described above are merely embodiments of the present disclosure and are not intended to limit the present disclosure. For those skilled in the art, the present disclosure may have various modifications or variations. Any amendment, equivalent substitution, improvement, etc. made under the spirit and principle of the present disclosure shall fall within the scope of the claims of the present disclosure.

What is claimed is:

1. A method performed by a network device in a wireless communication network, the method comprising:
configuring a distance condition that includes an area described by a combination of a plurality of subareas, wherein each of the subareas is a circular subarea described by a reference location and a distance threshold;
sending a configuration message carrying the distance condition to a terminal device, so that the terminal device determines whether to perform a predefined action according to the distance condition.

2. The method according to claim 1, wherein the configuring a distance condition that includes an area described by a combination of a plurality of subareas includes:
configuring a distance condition that includes a combined area described by a union of a plurality of subareas.

3. The method according to claim 2, wherein the configuring a distance condition that includes a combined area described by a union of a plurality of subareas includes:
configuring a distance condition that includes a combined area described by a subarea information list, wherein the subarea information list includes a plurality of pieces of subarea information, and each piece of subarea information includes: a subarea identifier, a reference location and a distance threshold.

4. The method according to claim 3, wherein the configuring a distance condition that includes a combined area described by a subarea information list includes: configuring a distance condition that includes a combined area, which is described by a subarea information list and formed by a combination of one or more pieces of subarea information; if the subarea information of the distance condition includes epoch time and ephemeris information, it indicates that the reference location described in the subarea information is a moving reference location; if the subarea information of the distance condition does not include the epoch time and the ephemeris information, it indicates that the reference location described in the subarea information is a fixed reference location; or
wherein the configuring a distance condition that includes a combined area described by a subarea information list includes: configuring a first distance condition that includes a combined area described by a subarea information list, wherein each piece of subarea information of the first distance condition includes: a subarea identifier, a fixed reference location and a distance threshold; configuring a second distance condition that includes a combined area described by a subarea information list, wherein each piece of subarea information of the second distance condition includes: a subarea identifier, a moving reference location, a distance threshold, epoch time and ephemeris information.

5. The method according to claim 2, wherein the distance condition includes a first condition and a second condition for the combined area, wherein the first condition is used to judge whether the terminal device is located within the combined area, and the second condition is used to judge whether the terminal device is located outside the combined area,
particularly wherein the first condition includes an inequality set Mn+Hys<Tn; the first condition is satisfied when any one of inequalities in the inequality set Mn+Hys<Tn holds true; if the distance condition is a newly added distance event in a report configuration of the configuration message, the first condition serves as an entering condition in the distance event; wherein Mn is a distance between the terminal device and an n-th reference location in the subarea information list; Hys is a hysteresis parameter, and Hys takes a value of zero or a specific non-zero value; and Tn is a distance threshold corresponding to the n-th reference location in the subarea information list; and/or wherein the second condition includes an inequality set Mn-Hys>Tn; the second condition is satisfied when all inequalities in the inequality set Mn-Hys>Tn hold true; if the distance condition is a newly added distance event in a report configuration of the configuration message, the second condition serves as a leaving condition in the distance event; wherein Mn is a distance between the terminal device and an n-th reference location in the subarea information list; Hys is a hysteresis parameter, and Hys takes a value of zero or a specific non-zero value; and Tn is a distance threshold corresponding to the n-th reference location in the subarea information list.

6. The method according to claim 3, wherein the combined area includes a terrestrial network area located within a non-terrestrial network area, and the configuring a distance condition that includes a combined area described by a subarea information list includes: configuring the distance condition that includes the combined area described by the subarea information list by reusing a coverage area information list in a system message,
particularly wherein the configuring the distance condition that includes the combined area described by the subarea information list by reusing a coverage area information list in a system message includes: configuring a terrestrial network area described by the union of a plurality of subareas in the coverage area information list; configuring a subarea identifier information list of the terrestrial network area in the distance condition, and associating the subarea identifier information list with the coverage area information list.

7. The method according to claim 1, wherein the configuring a distance condition that includes an area described by a combination of a plurality of subareas includes:
configuring a distance condition that includes an overlapping area described by an intersection of a plurality of subareas.

8. The method according to claim 7, wherein the configuring a distance condition that includes an overlapping area described by an intersection of a plurality of subareas includes: configuring a distance condition that includes an overlapping area described by an overlapping area information list, wherein the overlapping area information list includes at least one piece of overlapping area information, each of overlapping areas is described by two intersecting subareas and identified by an overlapping area identifier; and each of the subareas includes: a subarea identifier, a reference location and a distance threshold,
particularly wherein the configuring a distance condition that includes an overlapping area described by an overlapping area information list includes: configuring a distance condition that includes an overlapping area, which is described by an overlapping area information list and formed by a combination of one or more pieces of overlapping area information; if the overlapping area information of the distance condition includes epoch time and ephemeris information, it indicates that the reference location described in the overlapping area information is a moving reference location; and if the overlapping area information of the distance condition does not include the epoch time and the ephemeris information, it indicates that the reference location described in the overlapping area information is a fixed reference location; or
wherein the configuring a distance condition that includes an overlapping area described by an overlapping area information list includes: configuring a first distance condition that includes an overlapping area described by an overlapping area information list, wherein each piece of overlapping area information of the first distance condition includes: an overlapping area identifier, a subarea identifier, a fixed reference location and a distance threshold; configuring a second distance condition that includes an overlapping area described by an overlapping area information list, wherein each piece of overlapping area information of the second distance condition includes: an overlapping area identifier, a subarea identifier, a moving reference location, a distance threshold, epoch time and ephemeris information.

9. The method according to claim 7, wherein the distance condition includes a third condition and a fourth condition for the overlapping area, wherein the third condition is used to judge whether the terminal device is located within the overlapping area, and the fourth condition is used to judge whether the terminal device is located outside the overlapping area,
particularly wherein the third condition includes a set of inequality logical combinations: (Mn1+Hys<Tn1)&(Mn2+Hys<Tn2); the third condition is satisfied when any one of the inequality logical combinations in the set of inequality logical combinations (Mn1+Hys<Tn1)&(Mn2+Hys<Tn2) holds true; if the distance condition is a newly added distance event in a report configuration of the configuration message, the third condition serves as an entering condition in the distance event; wherein Mn1 is a distance from the terminal device to a first reference location of an n-th overlapping area information in the overlapping area information list; Hys is a hysteresis parameter, Hys takes a value of zero or a specific non-zero value; Tn1 is a distance threshold corresponding to the first reference location of the n-th overlapping area information in the overlapping area information list; & represents an AND operation; Mn2 is a distance from the terminal device to a second reference location of the n-th overlapping area information in the overlapping area information list; and Tn2 is a distance threshold corresponding to the second reference location of the n-th overlapping area information in the overlapping area information list; and/or
wherein the fourth condition includes a set of inequality logical combinations: (Mn1 - Hys > Tn1)|(Mn2 - Hys > Tn2); the fourth condition is satisfied when all inequality logical combinations in the set of inequality logical combinations (Mn1 - Hys > Tn1)|(Mn2 - Hys > Tn2) hold true; if the distance condition is a newly added distance event in a report configuration of the configuration message, the fourth condition serves as a leaving condition in the distance event; wherein Mn1 is a distance from the terminal device to a first reference location of an n-th overlapping area information in the overlapping area information list; Hys is a hysteresis parameter, and Hys takes a value of zero or a specific non-zero value; Tn1 is a distance threshold corresponding to the first reference location of the n-th overlapping area information in the overlapping area information list; | represents an OR operation; Mn2 is a distance from the terminal device to a second reference location of the n-th overlapping area information in the overlapping area information list; and Tn2 is a distance threshold corresponding to the second reference location of the n-th overlapping area information in the overlapping area information list.

10. The method according to claim 1, wherein the area includes any one of:
a cell coverage area; or
a beam coverage area.

11. The method according to claim 1, wherein the sending a configuration message carrying the distance condition to a terminal device includes: sending a configuration message carrying a measurement configuration or other configuration to a terminal device, wherein the measurement configuration includes an event trigger configuration for a measurement report or a conditional trigger configuration for conditional handover, wherein the distance condition is included in the event trigger configuration, the conditional trigger configuration or the other configuration, wherein the other configuration refers to a configuration field with a field name of “OtherConfig” in the configuration message,
particularly wherein a report configuration of the measurement configuration includes: indication information instructing the terminal device to carry a subarea identifier list in the sent measurement report, wherein the subarea identifier list includes subarea identifiers of one or more subareas where the terminal device is located, more particularly wherein the report configuration further includes: indication information instructing the terminal device to update the measurement report when the subarea identifier of the subarea where the terminal device is located changes; and/or wherein the report configuration further includes: indication information instructing the terminal device to carry an overlapping area identifier list in the sent measurement report, wherein the overlapping area identifier list includes overlapping area identifiers of one or more overlapping areas where the terminal device is located; and/or wherein the report configuration further includes: indication information instructing the terminal device to update the measurement report when an overlapping area identifier of the overlapping area where the terminal device is located changes,
particularly wherein a subarea report configuration that includes a subarea information list is newly added to the other configuration, so that the terminal device is capable of reporting a subarea identifier list of sub-areas where the terminal device is located by means of user equipment assistance information upon receiving the subarea report configuration, judging whether the terminal device is within an area indicated by the subarea information list, and reporting the user equipment assistance information again when the subarea where the terminal device is located changes, more particularly wherein the subarea report configuration further includes a transmission frequency limitation parameter for the user equipment assistance information,
particularly wherein an overlapping area report configuration that includes an overlapping area information list is newly added to the other configuration, so that the terminal device is capable of reporting an overlapping area identifier list of overlapping areas where the terminal device is located by means of user equipment assistance information upon receiving the subarea report configuration, judging whether the terminal device is within an area indicated by the overlapping area information list, and reporting the user equipment assistance information again when the overlapping area where the terminal device is located changes, more particularly wherein the overlapping area report configuration further includes a transmission frequency limitation parameter for the user equipment assistance information, most particularly, wherein the transmission frequency limitation parameter includes any one of: a prohibition time (ProhibitTimer); a trigger time (timeToTrigger); or a hysteresis parameter (hysteresisLocation),
particularly wherein the distance condition includes a newly added distance event in a report configuration of the measurement configuration.

12. The method according to claim 1, wherein the performing a predefined action includes one of:
sending a measurement report based on the distance condition to the network device;
sending user equipment assistance information based on the distance condition to the network device;
performing conditional handover; or
initiating signal strength measurement,
particularly wherein the method further comprising:
identifying a location of the terminal device in the area according to the measurement report or the user equipment assistance information;
configuring a new configuration message according to the location of the terminal device in the area;
sending the new configuration message to the terminal device,
more particularly wherein the new configuration message includes any one of:
a configuration message instructing the terminal device to initiate signal strength measurement;
a configuration message instructing the terminal device to configure or update a measurement gap configuration and an SSB measurement time configuration;
a configuration message instructing the terminal device to perform handover or conditional handover; or
a configuration message for performing interference avoidance on the terminal device located in an overlapping area.

13. A method performed by a terminal device in a wireless communication network, the method comprising:
receiving a configuration message carrying a distance condition sent by a network device, wherein the distance condition includes an area described by a combination of a plurality of subareas, and each of the subareas is a circular subarea described by a reference location and a distance threshold;
determining whether to perform a predefined action according to the distance condition.

14. The method according to claim 13, wherein the configuration message of the distance condition includes:
a distance condition for a combined area described by a union of a plurality of subareas,
particularly wherein the distance condition for a combined area described by a union of a plurality of subareas includes:
a distance condition for a combined area described by a subarea information list, wherein the subarea information list includes a plurality of pieces of subarea information, and each piece of subarea information includes a subarea identifier, a reference location and a distance threshold.

15. The method according to claim 13, wherein the configuration message of the distance condition includes:
a distance condition that includes an overlapping area described by an intersection of a plurality of subareas,
particularly wherein the distance condition that includes an overlapping area described by an intersection of a plurality of subareas includes:
a distance condition for an overlapping area described by an overlapping area information list, wherein the overlapping area information list includes at least one piece of overlapping area information, each of overlapping areas is described by two intersecting subareas and identified by an overlapping area identifier, and each of the subareas includes: a subarea identifier, a reference location and a distance threshold.

16. The method according to claim 13, wherein the area includes any one of:
a cell coverage area; or
a beam coverage area.

17. The method according to claim 13, wherein the receiving a configuration message carrying a distance condition sent by a network device includes: receiving a configuration message carrying a measurement configuration or other configuration sent by a network device, wherein the measurement configuration includes an event trigger configuration for a measurement report or a conditional trigger configuration for conditional handover, wherein the distance condition is included in the event trigger configuration, the conditional trigger configuration or the other configuration, wherein the other configuration refers to a configuration field with a field name of “OtherConfig” in the configuration message,
particularly wherein a report configuration of the measurement configuration includes: indication information instructing the terminal device to carry a subarea identifier list in the sent measurement report, wherein the subarea identifier list includes subarea identifiers of one or more subareas where the terminal device is located, more particularly wherein the report configuration further includes: indication information instructing the terminal device to update the measurement report when the subarea identifier of the subarea where the terminal device is located changes; and/or wherein the report configuration further includes: indication information instructing the terminal device to carry an overlapping area identifier list in the sent measurement report, wherein the overlapping area identifier list includes overlapping area identifiers of one or more overlapping areas where the terminal device is located; and/or wherein the report configuration further includes: indication information instructing the terminal device to update the measurement report when the overlapping area identifier of the overlapping area where the terminal device is located changes;
particularly wherein a subarea report configuration that includes a subarea information list is newly added to the other configuration, so that the terminal device is capable of reporting a subarea identifier list of sub-areas where the terminal device is located by means of user equipment assistance information upon receiving the subarea report configuration, judging whether the terminal device is within an area indicated by the subarea information list, and reporting the user equipment assistance information again when the subarea where the terminal device is located changes, more particularly wherein the subarea report configuration further includes a transmission frequency limitation parameter for the user equipment assistance information;
particularly wherein an overlapping area report configuration that includes an overlapping area information list is newly added to the other configuration, so that the terminal device is capable of reporting the overlapping area identifier list of overlapping areas where the terminal device is located by means of user equipment assistance information upon receiving the subarea report configuration, judging whether the terminal device is within an area indicated by the overlapping area information list, and reporting the user equipment assistance information again when the overlapping area where the terminal device is located changes, more particularly wherein the overlapping area report configuration further includes a transmission frequency limitation parameter for the user equipment assistance information, most particularly wherein the transmission frequency limitation parameter includes any one of: a prohibition time (ProhibitTimer); a trigger time (timeToTrigger); or a hysteresis parameter (hysteresisLocation);
particularly wherein the distance condition includes a newly added distance event in the report configuration of the measurement configuration.

18. The method according to claim 13, wherein the performing a predefined action includes one of:
sending a measurement report based on the distance condition to the network device;
sending user equipment assistance information based on the distance condition to the network device;
performing conditional handover; or
initiating signal strength measurement,
particularly wherein the distance condition triggering method further includes: receiving a new configuration message carrying a measurement configuration or other configuration sent by the network device.

19. The method according to claim 18, wherein the new configuration message includes any one of:
a configuration message instructing the terminal device to initiate signal strength measurement;
a configuration message instructing the terminal device to configure or update a measurement gap configuration and an SSB measurement time configuration;
a configuration message instructing the terminal device to perform handover or conditional handover; or
a configuration message for performing interference avoidance on the terminal device located in the overlapping area.

20. A terminal device, comprising:
at least one processor; and
at least one memory which stores instructions thereon, wherein when executed individually or collectively by the at least one processor, the instructions cause the terminal device to perform the method according to claim 13.
